(19) United States
(12) Patent Application Publication
(10) Pub. No.: US 2024/0303551 A1
(43) Pub. Date: Sep. 12, 2024

(54) REAL-TIME PREDICTION OF FUTURE EVENTS USING TRAINED ARTIFICIAL INTELLIGENCE PROCESSES AND INFERRED GROUND-TRUTH LABELS

(71) Applicant: The Toronto-Dominion Bank, Toronto (CA)

(72) Inventors: He LI, Toronto (CA); Jesse Cole CRESSWELL, Toronto (CA); Jean-Christophe BOUÉTTÉ, Montreal (CA); Mahdi GHELICHI, Toronto (CA); Zhiyi CHEN, Toronto (CA); George Frazer STEIN, Port Coquitlam (CA); Peter STARSZYK, Waterloo (CA); Xiaochen ZHANG, Toronto (CA)

(21) Appl. No.: 18/139,072

(22) Filed: Apr. 25, 2023

Related U.S. Application Data
(60) Provisional application No. 63/450,915, filed on Mar. 8, 2023.

(51) Int. Cl. G06N 20/20

(52) U.S. Cl. CPC G06N 20/20

(57) ABSTRACT

The disclosed embodiments include computer-implemented apparatuses and processes that facilitate a real-time prediction of future events using trained artificial-intelligence processes and inferred ground-truth labelling in multiple data populations. For example, an apparatus may receive application data characterizing an exchange of data from a device, and based on an application of an artificial-intelligence process to an input dataset that includes at least a portion of the application data, the apparatus may generate, in real time, output data indicative of a likelihood of an occurrence of at least one targeted event associated with the data exchange during a future temporal interval. The artificial-intelligence process may trained using datasets associated with inferred ground-truth labels and multiple data populations, and the apparatus may transmit at least a portion of the output data to the device for presentation within a digital interface.

### CROSS-REFERENCE TO RELATED APPLICATION

This application claims the benefit of priority under 35 U.S.C. § 119(e) to prior U.S. Application No. 63/450,915, filed Mar. 8, 2023, the disclosure of which is incorporated by reference herein to its entirety.

### TECHNICAL FIELD

The disclosed embodiments generally relate to computer-implemented systems and processes that facilitate a real-time prediction of future events using trained artificial-intelligence processes and inferred ground-truth labelling in multiple data populations.

### BACKGROUND

Today, financial institutions offer a variety of financial products or services to their customers, both through in-person branch banking and through various digital channels, and decisions related to the provisioning of a particular financial product or service to a customer are often informed by the customer's relationship with the financial institution and the customer's use, or misuse, of other financial products or services, and are based on information provisioned during completion of a product- or service-specific application process by the customers.

### SUMMARY

In some examples, an apparatus includes a memory storing instructions, a communications interface, and at least one processor coupled to the memory and the communications interface. The at least one processor is configured to execute the instructions to receive, from a device via the communications interface, application data characterizing an exchange of data. The at least one processor is further configured to execute the instructions to, based on an application of an artificial-intelligence process to an input dataset that includes at least a portion of the application data, generate, in real time, output data indicative of a likelihood of an occurrence of at least one targeted event associated with the data exchange during a future temporal interval. The artificial-intelligence process is trained using datasets associated with inferred ground-truth labels. The at least one processor is further configured to execute the instructions to transmit at least a portion of the output data to the device via the communications interface. The device is configured to present a graphical representation of the portion of the output data within a digital interface.

In other examples, a computer-implemented method includes receiving, using at least one processor and from a device, application data characterizing an exchange of data. The computer-implemented method also includes, using the at least one processor, and based on an application of an artificial-intelligence process to an input dataset that includes at least a portion of the application data, generating, in real time, output data indicative of a likelihood of an occurrence of at least one targeted event associated with the data exchange during a future temporal interval. The artificial-intelligence process is trained using datasets associated with inferred ground-truth labels. Further, the computer-implemented method includes transmitting, using the at least one processor, at least a portion of the output data to the device. The device is configured to present a graphical representation of the portion of the output data within a digital interface.

In various examples, a tangible, non-transitory computer-readable medium stores instructions that, when executed by at least one processor, cause the at least one processor to perform a method that includes receiving, from a device, application data characterizing an exchange of data. The method also includes, based on an application of an artificial-intelligence process to an input dataset that includes at least a portion of the application data, generating, in real time, output data indicative of a likelihood of an occurrence of at least one targeted event associated with the data exchange during a future temporal interval. The artificial-intelligence process is trained using datasets associated with inferred ground-truth labels. The method includes, transmitting at least a portion of the output data to the device. The device is configured to present a graphical representation of the portion of the output data within a digital interface.

It is to be understood that both the foregoing general description and the following detailed description are exemplary and explanatory only and are not restrictive of the invention, as claimed. Further, the accompanying drawings, which are incorporated in and constitute a part of this specification, illustrate aspects of the present disclosure and together with the description, serve to explain principles of the disclosed exemplary embodiments, as set forth in the accompanying claims.

### BRIEF DESCRIPTION OF THE DRAWINGS

FIGS. 1 and 2A are block diagrams illustrating portions of an exemplary computing environment, in accordance with some exemplary embodiments.

FIG. 2B is a diagram of an exemplary timeline for adaptively training a machine-learning or artificial-intelligence process, in accordance with some exemplary embodiments.

FIGS. 2C, 3A, 3B, and 4 are block diagrams illustrating portions of an exemplary computing environment, in accordance with some exemplary embodiments.

FIGS. 5A, 5B, and 5C are flowcharts of an exemplary process for adaptively training, cross-validating, and testing a machine-learning or artificial-intelligence process using datasets having inferred ground-truth labels, in accordance with some exemplary embodiments.

FIG. 6 is a flowchart of an exemplary process 600 for predicting occurrences of future in real-time using trained, machine-learning or artificial-intelligence processes and inferred ground-truth labelling in multiple data populations, in accordance with some exemplary embodiments.

Like reference numbers and designations in the various drawings indicate like elements.

### DETAILED DESCRIPTION

Modern financial institutions offer a variety of financial products or services to their customers, both through in-person branch banking and through various digital channels, and decisions related to the provisioning of a particular financial product or service to a customer are often informed by the customer's relationship with the financial institution and the customer's use, or misuse, of other financial products or services. For example, one or more computing systems of a financial institution may obtain, generate, and maintain elements of profile data identifying the customer and characterizing the customer's relationship with the financial institution, elements of account data identifying and characterizing one or more financial products issued to the customer by the financial institution, elements of transaction data identifying and characterizing one or more transactions involving these issued financial products, or elements of reporting data, such as credit-bureau data associated with the customer. The elements of profile data, account data, transaction data, and reporting data may establish collectively a time-evolving risk profile for the customer, and the financial institution may base not only a decision to provision the particular financial product or service to the customer, but also a determination of one or more initial terms and conditions of the provisioned financial product or service, on the established risk profile.

By way of example, the particular financial product may include an unsecured lending product, such as a credit-card account, an existing or prospective customer of the financial institution may initiate an application for the unsecured lending product by providing input to a digital interface presented by an application program, such as a mobile banking application, executed at a corresponding client device 403A. Alternatively, the existing or prospective customer may elect to visit a physical branch of the financial institution, and may provide information to a representative of the financial institution, who may input the information into an additional digital interface presented by an application program executed at a device disposed at the physical branch. In either instance, the device operable by the existing or prospective customer, or the device operable by the representative of the financial institution, may transmit data characterizing the application for the unsecured lending product, such as the credit-card account, across a corresponding communications network to one or more computing systems of the financial institution, which may apply one or more existing adjudication processes to the data and render a decision that approves, or alternatively, rejects, the application.

The one or more existing adjudication processes may leverage an established risk profile for an application involved in an application for an unsecured lending product, such as a credit-card account, and a decision to approve, or alternatively, reject, the application by the one or more computing system may be informed by one or more predetermined, static adjudication criteria. For example, the predetermined, static adjudication criteria may establish, for any approved application, that a corresponding applicant be associated with a credit score that exceeds a predetermined threshold score or an assets-to-liabilities ratio that exceeds a predetermined threshold value. Further, in addition to approving an application for an unsecured lending product, such as a credit-card account, the one or more computing systems of the financial institution may also perform operations that fund the approved account (or alternatively, decline to fund the approved account), and upon approval and funding, the one or more computing systems of the financial institution may provision the unsecured lending product to the customer, who may fund transactions using the now-provisioned unsecured lending product.

In many instances, however, the application of these existing adjudication processes to a received application for an unsecured lending product, and the provisioning of a rendered decision to a corresponding applicant through a corresponding digital channel (e.g., directly via a device operable by the applicant or indirectly through a device operable by a representative of the financial institution) may be associated with delays of hours, if not days, between a submission of the application to the one or more computing systems of the financial institution and the rendering of the decision. Further, the reliance of these existing adjudication processes on certain predetermined, static adjudication criteria often renders these existing adjudication processes incapable of leveraging the corpus of customer profile, account, transaction, or reporting data characterizing not only an applicant for the unsecured lending product, but also characterizing other customers of the financial institution having demographic or financial characteristics similar to those of the applicant. Further, although certain adaptive techniques might leverage the corpus of customer profile, account, transaction, or reporting data maintained by the financial institution, these adaptive techniques are often trained, cross-validated, and ultimately tested using in-time and out-of-time data characterizing at most a use, or misuse, or approved and funded applications (and not any rejected or approved, but unfunded, applications), these adaptive techniques often exhibit an inferencing bias towards an adjudication strategy applied currently, or previously, by the financial institution to applications for the unsecured lending products

One or more of the exemplary processes described herein may train initially a machine-learning or artificial-intelligence process to predict a likelihood of an occurrence, or a non-occurrence, of one or more future targeted events involving an unsecured lending product based on datasets associated with a first population of applications for unsecured lending products approved and funded by the financial institution during one or more prior temporal intervals, and using corresponding, assigned ground-truth labels. Further, based on elements of explainability data characterizing a predictive outcome of the initially trained machine-learning or artificial-intelligence process, certain of these exemplary processes may determine or “infer” a ground-truth label for each of a second population of applications for unsecured lending products rejected, or approved but unfunded, by the financial institution during one or more prior temporal intervals, and may train further the machine-learning or artificial-intelligence process using datasets associated with the second population and using corresponding one of the inferred ground-truth labels. One or more of the exemplary processes described herein may also perform operations that generate an augmented feature set based on potions of the features associated with each of the initially, and further, trained machine-learning or artificial-intelligence process, and that additional train the machine-learning or artificial-intelligence process using datasets consistent with the augmented feature set and associated with the first and second populations of applications, and using corresponding ones of the assigned and inferred ground-truth labels.

Further, and based on an application of the trained machine-learning or artificial-intelligence process to an input dataset associated with a corresponding application for an unsecured lending product, certain of the exemplary processes described herein may facilitate a prediction, in real-time, of a likelihood of an occurrence, or a non-occurrence, of one or more targeted events involving the unsecured lending product during the future temporal interval, which may corresponding application with an expected positive outcome (e.g., a predicted non-occurrence of any of the targeted events during the future interval) or alternatively, with an expected negative outcome (e.g., a predicted occurrence of at least one of the targeted events during the future interval). In some instances, output data indicative of the predicted likelihood of the occurrence or non-occurrence the one or more targeted events involving the unsecured lending product during the future temporal interval and as such, the expected positive or negative outcome of the corresponding application, may inform a decision by the financial institution to approve or reject the corresponding application, which may be provisioned to a device operable by an applicant or a representative of the financial institution in real-time and contemporaneously with an initiation of the application (e.g., within a threshold time period, such as, but not limited to, ten second, thirty seconds, or one minute).

Certain of these exemplary processes, which adaptively train a machine-learning or artificial-intelligence process using datasets associated with respective training, validation, and testing periods and using corresponding assigned and inferred ground-truth labels, and which apply the trained and validated gradient-boosted, decision-tree process to an input dataset associated with a received application for unsecured lending product, may enable the one or more computing systems of the financial institution to provision a decision to approve, or alternatively, reject, the received application to a corresponding device in real-time and contemporaneously with both an initiation of the application by the corresponding device and a receipt of the corresponding application by the one or more computing systems of the financial institution. These exemplary processes may, for example, be implemented in addition to, or as alternative to, existing processes adaptive processes that introduce a bias towards an adjudication strategy currently or previously applied by the financial institution to the applications for the unsecured lending products.

### A. Exemplary Processes for Adaptively Training Machine-Learning or Artificial-Intelligence Processes in Distributed Computing Environments Using Inferred Ground-Truth Labelling

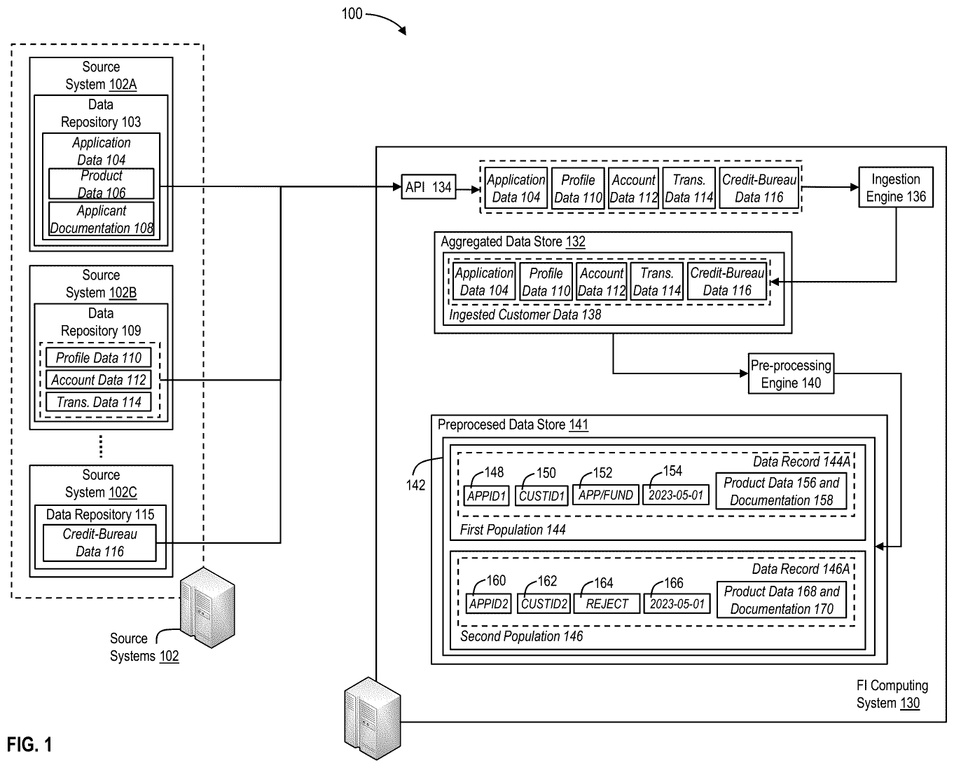

FIG. 1 illustrates components of an exemplary computing environment 100, in accordance with some exemplary embodiments. For example, as illustrated in FIG. 1, environment 100 may include one or more source systems 102, such as, but not limited to, source systems 102A, 102B, and 102C, and a computing system associated with, or operated by, a financial institution, such as financial institution (FI) computing system 130. In some instances, each of source systems 102 (including source systems 102A, 102B, and 102C) and FI computing system 130 may be interconnected through one or more communications networks, such as communications network 120. Examples of communications network 120 include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet.

In some instances, each of source systems 102 (including source systems 102A, 102B, and 102C) and FI computing system 130 may represent a computing system that includes one or more servers and tangible, non-transitory memories storing executable code and application modules. Further, the one or more servers may each include one or more processors, which may be configured to execute portions of the stored code or application modules to perform operations consistent with the disclosed embodiments. For example, the one or more processors may include a central processing unit (CPU) capable of processing a single operation (e.g., a scalar operation) in a single clock cycle. Further, each of source systems 102 (including source systems 102A, 102B, and 102C) and FI computing system 130 may also include a communications interface, such as a wireless transceiver, coupled to the one or more processors for accommodating wired or wireless internet communication with other computing systems and devices operating within environment 100.

Further, in some instances, source systems 102 (including source systems 102A, 102B, and 102C) and FI computing system 130 may each be incorporated into a respective, discrete computing system. In additional, or alternate, instances, one or more of source systems 102 (including source systems 102A, 102B, and 102C) and FI computing system 130 may correspond to a distributed computing system having a plurality of interconnected, computing components distributed across an appropriate computing network, such as communications network 120 of FIG. 1. For example, FI computing system 130 may correspond to a distributed or cloud-based computing cluster associated with, and maintained by, the financial institution, although in other examples, FI computing system 130 may correspond to a publicly accessible, distributed or cloud-based computing cluster, such as a computing cluster maintained by Microsoft Azure™ Amazon Web Services™, Google Cloud™, or another third-party provider.

By way of example, FI computing system 130 may include a plurality of interconnected, distributed computing components, such as those described herein (not illustrated in FIG. 1), which may be configured to implement one or more parallelized, fault-tolerant distributed computing and analytical processes (e.g., an Apache Spark™ distributed, cluster-computing framework, a Databricks™ analytical platform, etc.). Further, and in addition to the CPUs described herein, the distributed computing components of FI computing system 130 may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Through an implementation of the parallelized, fault-tolerant distributed computing and analytical protocols described herein, the distributed computing components of FI computing system 130 may perform any of the exemplary processes described herein to ingest elements of data associated with applications for unsecured lending products involving corresponding applicants, such as, but not limited to, one or more of the unsecured credit-card accounts described herein, associated with one or more prior temporal intervals. Further, and through the implementation of the parallelized, fault-tolerant distributed computing and analytical protocols described herein, the distributed computing components of FI computing system 130 may perform any of the exemplary processes described herein to preprocess the ingested data elements by filtering, aggregating, partitioning, and/or down-sampling certain portions of the ingested data elements, and to store the preprocessed data elements within an accessible data repository (e.g., within a portion of a distributed file system, such as a Hadoop™ distributed file system (HDFS)).

Referring back to FIG. 1, each of source systems 102 may maintain, within corresponding tangible, non-transitory memories, a data repository that includes confidential data associated with the customers of the financial institution and prior applications for the unsecured lending products (including the unsecured credit-card products described herein) during one or more temporal intervals. For example, internal source system 102A may be associated with, or operated by, the financial institution, and may maintain, within the corresponding one or more tangible, non-transitory memories, a source data repository 103 that includes elements of application data 104 that identify and characterize one or more applications for unsecured lending products during one or more temporal intervals. As described herein, the unsecured lending products may include, among other things, an unsecured credit-card account, and internal source system 102A may correspond to a distributed computing system having a plurality of interconnected, computing components distributed across an appropriate computing network, such as communications network 120 of FIG. 1, and internal source system 102A may maintain source data repository 103 within a portion of a distributed file system, such as a HDFS.

Each of the applications may be associated with a corresponding of the unsecured lending products described herein, such as, but not limited to, a credit-card account, and further, corresponding ones of the applications may be associated with, and may involve, a single applicant or alternatively, multiple applicants (e.g., “joint” applicants for the corresponding one of the applications for the unsecured lending products). For example, the single applicant, or one or more of the multiple applicants, may represent a current customer of the financial institution or alternatively, may represent a prospective customer of the financial institution. Further, in some examples, each of the applications for the unsecured lending products, such as the credit-card accounts described herein, may be associated with a corresponding, approval decision (e.g., a positive or negative decision) rendered by the financial institution on a corresponding decision date.

In some instances, the elements of application data 104 may include, for each of the applications for the unsecured lending products, a corresponding alphanumeric application identifier, decision data characterizing an approval decision for the corresponding application (e.g., an approval or a rejection), and temporal data identifying a time or date associated with an initiation of the corresponding application (e.g., an application date) and a date at which the financial institution rendered the approval decision (e.g., a decision date). Additionally, in some instances, application data 104 may also include elements of status data that characterize a current status of one or more of the approved applications for the unsecured lending products (e.g., approved and funded, approved but unfunded, etc.). Further, and for each of the applications, application data 104 may also maintain elements of product data 106, which identify and characterize the unsecured lending product (e.g., the credit-card account described herein) associated with the corresponding application, and elements of applicant documentation 108, identifying and characterizing each applicant, assets or liabilities of each applicant, and interactions of each applicant with the financial institution or with other financial institutions. In some instances, the elements of applicant documentation 108 may support an adjudication process applied to the corresponding application by the financial institution and the rendering of the corresponding approval decision.

By way of example, for a corresponding application, the elements of product data 106 may include, but are not limited to, a unique identifier of the corresponding unsecured lending product (e.g., a product name or alphanumeric identifier assigned to a credit-card account by FI computing system 130, etc.) and a value of one or more parameters of the corresponding unsecured lending product, such as a credit limit for the credit-card account or a fixed or variable interest rate. Further, and for the corresponding application, the elements of applicant documentation 108 may include, but are not limited to, an applicant identifier of each of applicant (e.g., an applicant name, an alphanumeric applicant identifier assigned by FI computing system 130, etc.), a governmental identifier assigned to each applicant (e.g., a driver's license number, a social security number, etc.), information characterizing a current residence and employment of each applicant, and information characterizing, among other things, and a current and temporal evolution of an income, assets, or liabilities associated with each applicant. The disclosed embodiments are, however, not limited to these exemplary elements of product data and applicant documentation, and in other instances, product data 106 and applicant documentation 108 may include any additional, or alternate, data identifying and characterizing, respectively, the corresponding unsecured lending product and each applicant would appropriate to support the adjudication of the corresponding application and the rendering of the corresponding approval decision.

Further, as illustrated in FIG. 1, source system 102B may also be associated with, or operated by, the financial institution, and may establish, within the one or more tangible, non-transitory memories, a data repository 109 that maintains elements of data identifying or characterizing one or more existing customers of the financial institution and interactions between these customers and the financial institution, such as, but not limited to, elements of customer profile data 110, elements of account data 112, and elements of transaction data 114. In some instances, the elements of customer profile data 110 may include, but are not limited to, one or more unique customer identifiers (e.g., an alphanumeric identifier, an alphanumeric character string, such as a login credential or a customer name, etc.), residence data (e.g., a street address, a city or town of residence, etc.), other elements of contact information (e.g., a mobile number, an email address, etc.), values of demographic parameters that characterize the particular customer (e.g., ages, occupations, marital status, etc.), and other data characterizing the relationship between the particular customer and the financial institution (e.g., a customer tenure at the financial institution, etc.).

In some instances, the elements of account data 112 may identify and characterize one or more financial products or financial instruments issued by the financial institution to corresponding ones of the existing customers. For example, the elements of account data 112 may include, for each of the financial products issued to corresponding ones of the existing customers, one or more identifiers of the financial product (e.g., an alphanumeric product, an account number, expiration data, card-security-code, etc.), one or more unique customer identifiers (e.g., an alphanumeric identifiers, an alphanumeric character string, such as a login credential or a customer name, etc.), and additional information characterizing a balance or current status of the financial product or instrument (e.g., payment due dates or amounts, delinquent accounts statuses, etc.). Examples of these financial products may include, but are not limited to, a deposit account (e.g., a savings account, a checking account, etc.), a brokerage or retirements account, and a secured or unsecured credit or lending products (e.g., a real-estate secured lending product, an auto loan, a credit-card account, a personal loan, or an unsecured line-of-credit).

Further, the elements of transaction data 114 may identify and characterize initiated, settled, or cleared transactions involving respective ones of the existing customers and corresponding ones of the issued financial products. Examples of these transactions include, but are not limited to, purchase transactions, bill-payment transactions, electronic funds transfers, currency conversions, purchases of securities, derivatives, or other tradeable instruments, electronic funds transfer (EFT) transactions, peer-to-peer (P2P) transfers or transactions, or real-time payment (RTP) transactions. For instance, and for a particular transaction involving a corresponding customer and corresponding financial product, the elements of transaction data 114 may include, but are limited to, the customer identifier of the corresponding customer (e.g., the alphanumeric character string described herein, etc.), a counterparty identifier (e.g., an alphanumeric character string, a counterparty name, etc.), an identifier of the corresponding financial product (e.g., a tokenized account number, expiration data, card-security-code, etc.), and values of one or more parameters of the particular transaction (e.g., a transaction amount, a transaction date, etc.).

The disclosed embodiments are, however, not limited to these exemplary elements of customer profile data 110, account data 112, or transaction data 114 and in other instances, the elements of customer profile data 110, account data 112, and transaction data 114 may include, respectively, any additional or alternate elements of data that identify and characterize the customers of the financial institution and their relationships or interactions with the financial institution, financial products issued to these customers by the financial institution, and transactions involving corresponding ones of the customers and the issued financial products. Further, although stored in FIG. 1 within data repositories maintained by source system 102B, the exemplary elements of customer profile data 110, account data 112, or transaction data 114 may be maintained by any additional or alternate computing system associated with the financial institution, including, but not limited to, within one or more tangible, non-transitory memories of FI computing system 130.

In some instances, source system 102C may be associated with, or operated by, one or more judicial, regulatory, governmental, or reporting entities external to, and unrelated to, the financial institution. For example, source system 102C may be associated with, or operated by, a reporting entity, such as a credit bureau, and source system 102C may maintain, within the corresponding one or more tangible, non-transitory memories, a source data repository 115 that includes elements of credit-bureau data 116 associated with one or more existing (or prospective) customers of the financial institution, including one or more applicants involved in the applications for the unsecured lending products described herein. In some instances, and for a particular one of the existing (or prospective) customers of the financial institution, the elements of credit-bureau data 116 may include, but are not limited to, an identifier of the particular customer (e.g., an alphanumeric identifier or login credential, a customer name, etc.), a current credit score or information establishing a temporal evolution of credit scores for the particular customer, information identifying one or more financial products currently or previously held by the particular customer (e.g., the financial products issued by the financial institution, etc.), information identifying a history of payments associated with these financial products, information identifying occurrences and durations negative events associated with the particular customer (e.g., delinquency events, write-offs, etc.), and information identifying credit inquiries involving the particular customer (e.g., inquiries by the financial institution, etc.).

In some instances, FI computing system 130 may perform operations that establish and maintain one or more centralized data repositories within corresponding ones of the tangible, non-transitory memories. For example, as illustrated in FIG. 1, FI computing system 130 may establish an aggregated data store 132, which maintains, among other things, elements of application data 104 (including the corresponding application identifiers, elements of decision data and temporal data, and elements of product data 106 and applicant documentation 108), customer profile data 110, account data 112, transaction data 114, and credit-bureau data 116 that characterize one or more of the existing (or prospective) customers of the financial institution. FI computing system 130 may perform operations, described herein, to ingest the elements of application data 104, customer profile data 110, account data 112, transaction data 114, and credit-bureau data 116 for one or more of source systems 102, and aggregated data store 132 may, in some instances, correspond to a data lake, a data warehouse, or another centralized repository established and maintained, respectively, by the distributed components of FI computing system 130, e.g., such an HDFS, etc. . . .

For example, FI computing system 130 may execute one or more application programs, elements of code, or code modules that, in conjunction with the corresponding communications interface (not illustrated in FIG. 1), establish a secure, programmatic channel of communication with each of source systems 102, including source systems 102A, 102B, and 102C, and may perform operations that access and obtain all, or a selected portion, of the elements of application data 104, customer profile data 110, account data 112, transaction data 114, and credit-bureau data 116 maintained by corresponding ones of source systems 102A, 102B, and 102C.

As illustrated in FIG. 1, source system 102A may perform operations that obtain all, or a selected subset, of the elements of application data 104 (including the corresponding application identifiers, elements of decision data and temporal data, and elements of product data 106 and applicant documentation 108) from source data repository 103, and transmit the obtained portions of application data 104 across communications network 120 to FI computing system 130. Further, source system 102B may perform operations that obtain all, or a selected subset, the elements of customer profile data 110, account data 112, and transaction data 114 from data repository 109, and transmit the obtained elements of customer profile data 110, account data 112, and transaction data 114 across communications network 120 to FI computing system 130. Source system 102C may also perform operations that obtain all, or a selected portion, of the elements of credit-bureau data 116 from source data repository 115, and transmit the obtained elements of credit-bureau data 116 across communications network 120 to FI computing system 130.

A programmatic interface established and maintained by FI computing system 130, such as application programming interface (API) 134, may receive: (i) the elements of application data 104 (including the corresponding application identifiers, elements of decision data and temporal data, and elements of product data 106 and applicant documentation 108) from source system 102A; (ii) the elements of customer profile data 110, account data 112, and transaction data 114 from source system 102B; and (iii) the elements of credit-bureau data 116 from source system 102C. As illustrated in FIG. 1, API 134 may route the elements of application data 104, customer profile data 110, account data 112, transaction data 114, and credit-bureau data 116 to a data ingestion engine 136 executed by FI computing system 130.

Executed data ingestion engine 136 may also perform operations that store the elements of application data 104, customer profile data 110, account data 112, transaction data 114, and credit-bureau data 116 in the one or more tangible, non-transitory memories of FI computing system 130, e.g., as ingested customer data 138 within aggregated data store 132. Although not illustrated in FIG. 1, executed data ingestion engine 136 may also store, within aggregated data store 132, the elements of ingested customer data 138 in conjunction with additional, or alternate, elements of application, customer profile, account, transaction, and credit-bureau data ingested from corresponding ones of source systems 102A, 102B, and 102C by executed data ingestion engine 136 during one or more prior temporal intervals. In some instances, each of the ingested elements of application data 104, customer profile data 110, account data 112, transaction data 114, and credit-bureau data 116 may be associated with additional elements of temporal data that characterize a date or time at which executed data ingestion engine 136 received the corresponding elements of application, customer profile, account, transaction, or credit-bureau data from one or more of source systems 102 and stored the corresponding elements of application, customer profile, account, transaction, or credit-bureau data within aggregated data store 132 (e.g., “ingested” the corresponding elements of customer profile, account, transaction, or credit-bureau data).

A pre-processing engine 140 executed by the one or more processors of FI computing system 130 may access the elements of application data 104 maintained within ingested customer data 138, including the corresponding application identifiers, elements of decision data and temporal data, and the elements of product data 106 and applicant documentation 108, and may perform any of the exemplary data-processing operations described herein to parse the accessed elements of application data 104, to selectively aggregate, filter, and process the accessed elements of application data 104, and to generate data records 142 that characterize corresponding ones of the applications for the unsecured lending products (including the credit-card accounts described herein). Further, as illustrated in FIG. 1, executed pre-processing engine 140 may also perform operations that sort or partition each of data records 142 into: (i) a first population 144 of data records characterizing applications that are both approved by the financial institution and funded for use by the financial institution subsequent to approval; and (ii) a second population 146 of data records characterizing applications that are either rejected by the financial institution, or alternatively, that are approved by the financial institution but remain unfunded.

By way of example, first population 144 may include a data record 144A associated with an application for a credit-card account by an existing customer of the financial institution, which the financial institution approved on May 1, 2023, and subsequently funded for use in purchases and other transactions initiated by the customer. As illustrated in FIG. 1, data record 144A may include an application identifier 148 (e.g., an alphanumeric “APPID1”), an applicant identifier 150 (e.g., an alphanumeric “CUSTID1” of the existing customer), decision and status data 152 characterizing the decision to approve and fund the corresponding application (e.g., “APP/FUND”), and temporal data 154 identifying the decision date of May 1, 2023 (e.g., “2023-05-01”). Data record 144A may also include elements of product data 156 that identify and characterize the credit-card account associated with the approved application (e.g., as obtained from a corresponding portion of product data 106), and elements of applicant documentation 158 that identifies and characterizes the applicant involved in the application, e.g., the existing customer associated with applicant identifier 150.

Further, and by way of example, second population 146 may include a data record 146A associated with an application for a credit-card account by an existing customer of the financial institution, which the financial institution rejected on May 1, 2023. As illustrated in FIG. 1, data record 146A may include an application identifier 160 (e.g., an alphanumeric “APPID2”), an applicant identifier 162 (e.g., an alphanumeric “CUSTID2” of the existing customer), decision and status data 164 characterizing the decision to reject the corresponding application (e.g., “REJECT”), and temporal data 166 identifying the corresponding decision date (e.g., “2023-05-01”). Data record 146A may also include elements of product data 168 that identify and characterize the credit-card account associated with the rejected application (e.g., as obtained from a corresponding portion of product data 106), and elements of applicant documentation 170 that identifies and characterizes the applicant involved in the rejected application, e.g., the existing customer associated with applicant identifier 162.

In some instances, executed pre-processing engine 140 may consolidate and/or aggregate certain of the obtained elements, through an invocation of an appropriate Java-based SQL “join” command (e.g., an appropriate “inner” or “outer” join command, etc.). Further, executed pre-processing engine 140 may perform any of the exemplary processes described herein to generate a data record of first population 144 for each additional, or alternate, approved and funded application for the unsecured lending products characterized by corresponding elements of application data 104, and to generate a data record of second population 146 for each additional, or alternate, application for an unsecured credit-card account rejected by the financial institution, or approved by the financial institution and subsequently unfunded, as identified and characterized by corresponding elements of application data 104.

In some instances, FI computing system 130 may perform any of the exemplary operations described herein to train adaptively a machine-learning or artificial-intelligence process (e.g., the gradient-boosted, decision-tree process described herein) to predict a likelihood of an occurrence, or a non-occurrence, of one or more targeted events involving an unsecured lending product associated with a corresponding application during a future temporal interval. The exemplary adaptive training processes described herein may, for example, leverage in-time training and validation datasets, and out-of-time testing datasets, associated with temporally distinct subsets of the data records. In some examples, the future temporal interval may include an eighteen-month period disposed subsequent to a decision date of the corresponding application for the unsecured lending product, and the targeted events may include, but are not limited to, a delinquency event involving the unsecured lending product and characterized by a duration of greater than a threshold duration (e.g., ninety days, etc.) or an occurrence of a write-off of at least a threshold balance (e.g., $150.00, etc.) involving the unsecured lending product.

As described herein, the machine-learning or artificial-intelligence process may include an ensemble or decision-tree process, such as a gradient-boosted decision-tree process (e.g., the XGBoost process), and the training, validation, and testing datasets may include, but are not limited to, values of adaptively selected features obtained, extracted, or derived from the data records of first population 144, the data records of second population 146, and additionally or alternatively, combinations of the data records of first population 144 and second population 146, as maintained within pre-processed data store 141, along with corresponding assigned ground-truth labels (e.g., assigned to the data records of first population 144 based on corresponding, previously ingested elements of customer account or transaction data) or inferred ground-truth labels (e.g., assigned to the data records of second population 146 using any of the exemplary processes described herein). For example, the distributed computing components of FI computing system 130 (e.g., that include one or more GPUs or TPUs configured to operate as a discrete computing cluster) may perform any of the exemplary processes described herein to adaptively train, cross-validate, and test the machine-learning or artificial-intelligence process in parallel through an implementation of one or more parallelized, fault-tolerant distributed computing and analytical processes. Based on an outcome of these adaptive training processes, FI computing system 130 may generate process coefficients, parameters, thresholds, and other process data that collectively specify the trained machine-learning or artificial-intelligence process, and may store the generated process coefficients, parameters, thresholds, and process data within a locally or remotely accessible data repository.

Further, and based on an application of the trained machine-learning or artificial-intelligence process to an input dataset associated with a corresponding application for an unsecured lending product in real-time, certain of the exemplary predictive processes described herein may facilitate a prediction, in real-time, likelihood of an occurrence, or a non-occurrence, of one or more targeted events involving the unsecured lending product during the future temporal interval, and further, may associate, the corresponding application with an expected positive outcome (e.g., a predicted non-occurrence of any of the targeted events during the future interval) or alternatively, with an expected negative outcome (e.g., a predicted occurrence of at least one of the targeted events during the future interval). In some instances, output data indicative of the predicted likelihood of the occurrence or non-occurrence the one or more targeted events involving the unsecured lending product during the future temporal interval and as such, the expected positive or negative outcome of the corresponding application, may inform a decision by the financial institution to approve or reject the corresponding application for the unsecured lending product, which may be provisioned to a device operable by an applicant or a representative of the financial institution in real-time and contemporaneously with an initiation of the application (e.g., within a threshold time period, such as, but not limited to, ten second, twenty seconds, or thirty seconds).

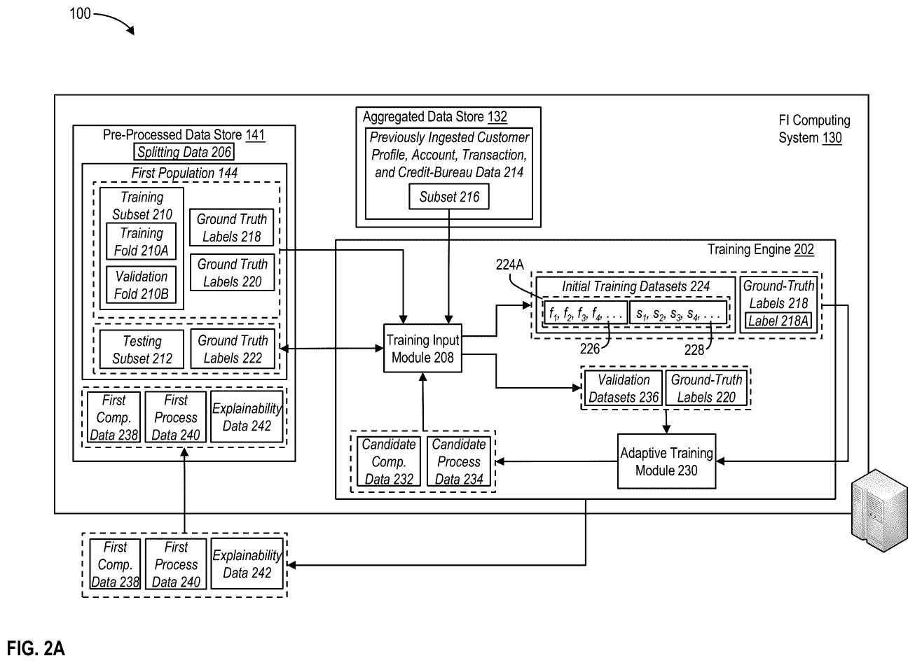

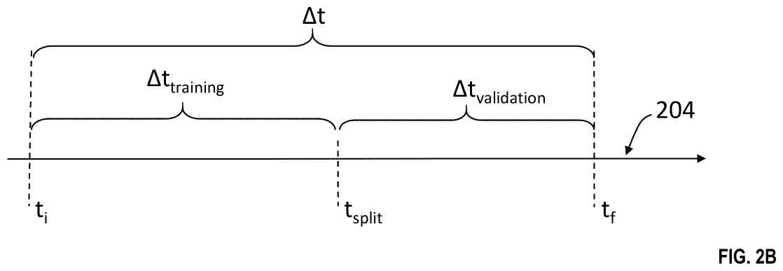

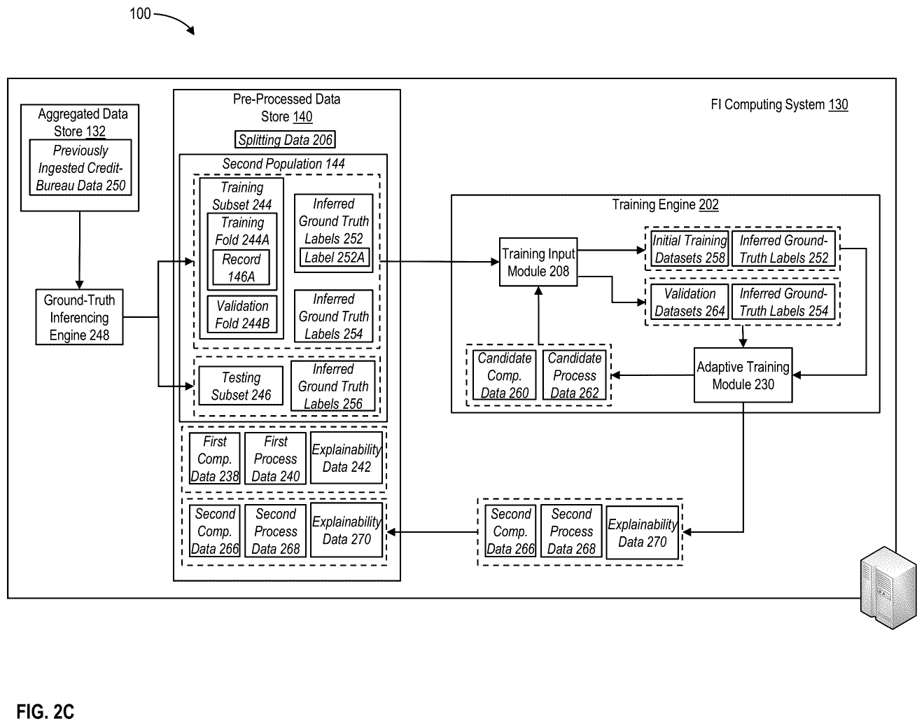

Referring to FIG. 2A, a training engine 202 executed by the one or more processors of FI computing system 130 may access portions of the data records maintained within pre-processed data store 141, such as, but not limited to, the data records partitioned into first population 144. As described herein, each of the data records of first population 144 may be associated with, and may characterize, a corresponding application for an unsecured lending product, such as a credit-card account, that is approved by the financial institution and funded for use in purchase transactions by the financial institution. For example, each of the data records of first population 144, such as data record 144A, may include an application identifier (e.g., application identifier 148 of FIG. 1), an applicant identifier of each applicant (e.g., applicant identifier 150 of FIG. 1), elements of decision and status data characterizing the decision to approve and fund the corresponding application (e.g., decision and status data 152 of FIG. 1), and temporal data identifying the decision (e.g., temporal data 154 of FIG. 1). Further, each of the data records of first population 144, including data record 144A, may also include elements of product data that identify and characterize the unsecured lending product associated with the corresponding approved and funded application (e.g., product data 156 of FIG. 1) and elements of applicant documentation that identify and characterize each applicant involved in the corresponding, approved and funded application (e.g., applicant documentation 158 of FIG. 1).

Executed training engine 202 may parse the accessed data records of first population 144, and based on corresponding ones of the temporal identifiers, determine that funded and approved applications for the unsecured lending products (e.g., the credit-card accounts described herein) are characterized by decision dates disposed throughout a range of prior temporal intervals. In some instances, executed training engine 202 may perform operations that decompose the determined range of prior temporal intervals into a corresponding first subset of the prior temporal intervals (e.g., the “training” interval described herein) and into a corresponding second, subsequent, and disjoint subset of the prior temporal intervals (e.g., the “validation” interval described herein). For example, as illustrated in FIG. 2B, the range of prior temporal intervals (e.g., shown generally as Δt along timeline 204 of FIG. 2B) may be bounded by, and established by, temporal boundaries tᵢ and t_{f}. Further, the decomposed first subset of the prior temporal intervals (e.g., shown generally as an in-time training interval Δt_{training} along timeline 204 of FIG. 2B) may be bounded by temporal boundary tᵢ and a corresponding splitting point tₛₚₗᵢₜ along timeline 204, and the decomposed second subset of the prior temporal intervals (e.g., shown generally an out-of-time testing interval Δt_{testing} along timeline 204 of FIG. 2B) may be bounded by splitting point tₛₚₗᵢₜ and temporal boundary t_{f}.

Referring back to FIG. 2A, executed training engine 202 may generate elements of splitting data 206 that identify and characterize the determined temporal boundaries tᵢ and t_{f} of the data records of first population 144 (and as described herein, of the data records of second population 146) and the range of prior temporal intervals established by the determined temporal boundaries Further, the elements of splitting data 206 may also identify and characterize the splitting point (e.g., the splitting point tₛₚₗᵢₜ described herein), the first subset of the prior temporal intervals (e.g., the in-time training interval Δt_{training} and corresponding boundaries described herein), and the second, and subsequent subset of the prior temporal intervals (e.g., the out-of-time testing interval Δt_{testing} and corresponding boundaries described herein). As illustrated in FIG. 2A, executed training engine 202 may store the elements of splitting data 206 within the one or more tangible, non-transitory memories of FI computing system 130, e.g., within pre-processed data store 141.

As described herein, each of the prior temporal intervals may correspond to a one-month interval, and executed training engine 202 may perform operations that establish adaptively the splitting point between the corresponding temporal boundaries such that a predetermined first percentage of the data records of first population 144 (and as described herein, of the data records of second population 146) characterize applications having decision dates disposed within the in-time training interval, and such that a predetermined second percentage of the data records of first population 144 (and as described herein, of the data records of second population 146) characterize applications having decision dates disposed within the out-of-time testing interval. For example, the first predetermined percentage may correspond to approximately forty-five percent of the data records, and the second predetermined percentage may corresponding to fifty-five percent of the data records, although in other examples, executed training engine 202 may compute one or both of the first and second predetermined percentages, and establish the decomposition point, based on the range of prior temporal intervals, the data records of first population 144 and/or second population 146, or a magnitude of the temporal intervals (e.g., one-month intervals, two-week intervals, one-week intervals, one-day intervals, etc.).

In some examples, a training input module 208 of executed training engine 202 may access the data records of first population 144, e.g., as maintained in pre-processed data store 141, and based on portions of splitting data 206, executed training input module 208 may perform operations that parse the data records of first population 144 and determine that: (i) a subset 210 of these data records are associated with approved and funded applications having decisions dates disposed within the training interval Δt_{training}, and as such, may be appropriate to train adaptively and cross-validate the machine-learning or artificial-intelligence process during the training interval Δt_{training}; and (ii) a subset 212 of these data records are associated with applications having final decision dates disposed within the out-of-time testing interval Δt_{testing}, and as such, may be appropriate to testing the adaptively trained and cross-validated machine-learning or artificial-intelligence process on previously unseen data prior to deployment.

Executed training input module 208 may also perform operations that decompose subset 210 of the data records into one or more partitions or folds that facilitate the adaptive training the machine-learning or artificial-intelligence process during the training interval Δt_{training}, such as, but not limited to training fold 210A, and one or more partitions or folds that facilitate a cross-validation of the adaptively trained machine-learning or artificial-intelligence process during the training and interval Δt_{training}, such as, but not limited to, validation fold 210B. For example, executed training input module 208 may perform operations that allocate equal portions of the data records of subset 210 to each of the training and validation partitions or folds (e.g., assign 50% of the data records of subset 210 to each of training fold 210A and validation fold 210B, etc.). Further, in some example, executed training input module 208 may perform operations that apportion or assign pre-determined or unequal portions of the data records of subset 210 to each of the training and validation partitions or folds, and additionally, or alternatively, that apportion or assign the data records of subset 210 to corresponding ones of the training and validation partitions or folds in a manner that maintains a statistical character of the applicants or applications characterized of the assigned data records (e.g., in accordance with a corresponding apportionment schema).

Executed training input module 208 may also perform operations that generate information characterizing a ground-truth label associated with each of the data records maintained within corresponding ones of training subset 210 (including each of the training and validation partitions or folds, such as training fold 210A and validation fold 210B) and testing subset 212. By way of example, and as described herein, each of data records of training subset 210 and testing subset 212 are associated with an approved, and funded, application for an unsecured lending product (e.g., a credit-card account, etc.), and as such, FI computing system 130 may maintain, for each of the unsecured lending products and for corresponding ones of the applicants, previously ingested elements of account data and transaction data that characterize not only the unsecured lending products, but also other financial accounts and payment instruments held by corresponding ones of the applicants, e.g., as portions of ingested customer data 138 of FIG. 1.

In some instances, and based on these previously ingested elements of account and transaction data, executed training input module 208 may perform operations that establish, for each of the approved and funded applications and associated data records of training subset 210 and testing subset 212, an occurrence of one or more targeted events involving corresponding ones of the unsecured lending products (e.g., the credit-card accounts, etc.) and/or corresponding ones of the applicants during a future temporal interval disposed subsequent to a corresponding decision date. As described herein, the future temporal interval may include an eighteen-month period, and the targeted events may include, but are not limited to, a delinquency event involving an unsecured lending product and characterized by a duration of greater than a threshold duration (e.g., ninety days) or an occurrence of a write-off of at least a threshold balance (e.g., $150.00) involving the unsecured lending product.

By way of example, executed training input module 208 may access one of the data records of training fold 210A, and may obtain a product identifier of a corresponding unsecured lending product (e.g., an account number of the credit-card account maintained within product data 156 of FIG. 1), a corresponding applicant identifier (e.g., applicant identifier 150 of FIG. 1), and a corresponding decision date (e.g., the May 1, 2023, decision date maintained within temporal data 154 of FIG. 1). Further, executed training input module 208 may also access one or more previously ingested elements 214 of customer profile, account, transaction, and credit-bureau data maintained by FI computing system 130 (e.g., within aggregated data store 132), and based on the corresponding product and/or applicant identifiers, determine that a subset 216 of previously ingested elements 214 characterize the corresponding unsecured lending product or interactions of the one or more applicants with the corresponding unsecured lending product. Executed training input module 208 may perform further operations that, based on subset 216, establish the occurrence, or alternatively, the non-occurrence, of the one or more targeted events during the future temporal interval (e.g., the occurrence, or non-occurrence, of a delinquency event of at least a ninety-day duration involving the corresponding unsecured lending product and/or an occurrence of a write-off of at least the $150.00 threshold balance involving the unsecured lending product).

If, for example, executed training input module 208 were to establish a non-occurrence of each of the one or more targeted events involving the corresponding unsecured lending product during the future temporal interval, executed training input module 208 may generate a “positive” ground-truth label for the corresponding application (e.g., one of ground-truth labels 218) that associates the corresponding application within a positive outcome. Alternatively, executed training input module 208 were to establish an occurrence of at least one of the targeted events involving the corresponding unsecured lending product during the future temporal interval, executed training input module 208 may generate a “negative” ground-truth label for the corresponding, approved and funded application (e.g., one of ground-truth labels 218) that associates the corresponding, corresponding, approved and funded application within a positive negative outcome. As described herein, the positive and negative ground-truth labels may include numerical values indicative of the corresponding positive or negative outcomes (e.g., a value of zero of a positive outcome, and a value of unity for a negative outcome), and may represent respective positive and negative targets for the exemplary adaptive training, cross-validation, and testing processes described herein.

Executed training input module 208 may perform any of the exemplary processes described herein to generate a corresponding positive or negative one of ground-truth labels 218 for each additional, or alternate, pre-processed data record of training fold 210A of training subset 210. Further, executed training input module 208 may perform any of the exemplary processes described herein to generate a corresponding one of positive or negative ground-truth labels 220 for of the data records maintained within validation fold 210B of training subset 210, and to generate a corresponding one of positive or negative ground-truth labels 222 for of the data records maintained within testing subset 212. As illustrated in FIG. 2A, executed training input module 208 may perform operations that store ground-truth labels 218, 220, and 222 in corresponding portions of pre-processed data store 141, e.g., in conjunction or association with respective ones of training fold 210A and validation fold 210B of training subset 210 and testing subset 212.

In some instances, executed training input module 208 may perform operations that generate one or more initial training datasets 224 based on the data records allocated to training fold 210A, and additionally, or alternatively, based on elements of ingested customer profile, account, transaction, or credit-bureau data maintained within the one or more tangible, non-transitory memories of FI computing system 130 (e.g., within aggregated data store 132). As described herein, each of initial training datasets 224 may be associated with a corresponding one of the funded and approved applications for the unsecured lending products (e.g., a credit-card account, as described herein) characterized by decision date disposed within disposed within the training interval Δt_{training}, and further, may be associated with a corresponding one of ground-truth labels 218. In some instances, the plurality of initial training datasets 224 may, when provisioned to an input layer of the gradient-boosted decision-tree process described herein in conjunction with corresponding ones of the ground-truth labels 218, enable executed training engine 202 to train adaptively the gradient-boosted decision-tree process to predict a likelihood of an occurrence, or a non-occurrence, of one or more targeted events involving an unsecured lending product associated with a corresponding application during a future temporal interval, e.g., in real-time and on-demand upon receipt from a corresponding digital channel.

Each of initial training datasets 224 may include, among other things, an application identifier associated with that corresponding application, an applicant identifier of a corresponding applicant (or applicants), and temporal data characterizing the corresponding decision date, as described herein. Further, each of initial training datasets 224 may also include elements of data (e.g., feature values) that characterize the corresponding application for the unsecured lending product and additionally, or alternatively, the applicant (or applicants) involved in the corresponding application. In some instances, executed training input module 208 may perform operations that identify, and obtain or extract, one or more of the features values from the data records allocated to training fold 210A and associated with corresponding ones of the approved and funded applications and the corresponding applicant (or applicants), and additionally, or alternatively, from previously ingested elements of ingested customer profile, account, transaction, or credit-bureau data associated with the corresponding applicant or applicants.

By way of example, for a corresponding one of the approved and funded applications for the unsecured lending products, executed training input module 208 may access, within training fold 210A, one (or more) of the data records associated with the corresponding application, and identify, and obtain or extract, one or more of the feature values from portions of the accessed pre-processed data record or records (e.g., from the elements of product data 156 and applicant documentation 158 of data record 144A). Additionally, or alternatively, executed training input module 208 may obtain, from the accessed pre-processed data record or records, and applicant identifier associated with each of the applicants involved in the corresponding application, and based on the obtained applicant identifier (or identifiers), executed training input module 208 may perform any of the exemplary processes described herein to access one or more previously ingested elements of customer profile, account, transaction, and credit-bureau data (e.g., maintained within aggregated data store 132) that include, or reference, the applicant identifier (or identifiers) and as such, characterize the interactions of each of the applicants with the financial institution or with other financial institutions. In some instances, executed training input module 208 may perform operations that identify, and obtain or extract, additional, or alternative, ones of the feature values from the accessed, and previously ingested, elements of customer profile, account, transaction, and credit-bureau data.

The obtained or extracted feature values may, for example, include elements of the profile, account, transaction, and/or credit-bureau, (e.g., which may populate the data records maintained within training subset 210), and examples of these obtained or extracted feature values may include, but are not limited to, a number of overdraft drawdown involving the corresponding applicant during a predetermined prior temporal interval, a number of credit inquiries involving the corresponding applicant during a predetermined prior temporal interval, and temporal data characterizing a prior delinquency involving the corresponding applicant. These disclosed embodiments are, however, not limited to these examples of obtained or extracted feature values, and in other instances, training datasets 153 may include any additional or alternate element of data extracted or obtained from the data records of training subset 210, associated with corresponding ones of the applications and applicants. Further, executed training input module 208 may package the obtained or extracted features values for corresponding ones of the approved and funded applications into sequential positions within a corresponding, application-specific one of initial training datasets 224.

Further, in some instances, executed training input module 208 may also perform operations that compute, determine, or derive one or more of the features values for corresponding ones of the approved and funded applications based portions of the data records allocated to training fold 210A and associated with the corresponding application and additionally, or alternatively, from previously ingested elements of ingested customer profile, account, transaction, or credit-bureau data associated with the corresponding applicant or applicants, such as the previously ingested elements of ingested customer profile, account, transaction, or credit-bureau data maintained within aggregated data store 132, as described herein. Examples of these computed, determined, or derived feature values may include, but are not limited to, a total amount of funds held on behalf of the corresponding applicant by the financial institution, a sum of all unpaid charge- or write-offs involving the corresponding applicant, and an average utilization of credit across one or more unsecured credit products involving the applicant. These disclosed embodiments are, however, not limited to these examples of computed, determined, or derived feature values, and in other instances, training datasets 153 may include any additional or alternate featured computed, determine, or derived from data extracted or obtained from the data records of training fold 210A and associated with the corresponding application and corresponding ones of the applicants. Executed training input module 208 may package the computed, determined, or derived features values for corresponding ones of the approved and funded applications into sequential positions within a corresponding, application-specific one of initial training datasets 224.

Executed training input module 208 may also perform additional operations that, during the generation of initial training datasets 224, facilitate a dynamic and adaptive selection of statistically significant features through an implementation of one or more exemplary feature-selection processes described herein (e.g., via a Boruta feature-selection process). In some instances, for each of initial training datasets 224, executed training input module 208 may perform operations that permute or “shuffle” (e.g., randomly or pseudo-randomly) a corresponding sequence of feature values to generate a set of “shadow” feature values, which may be appended to the corresponding sequence of feature values (e.g., to generate an augmented dataframe for initial training datasets 224 having twice the number of columns of an initial dataframe).

For example, as illustrated in FIG. 2A, training dataset 224A of initial training datasets 224 may be associated with a corresponding ground-truth label 218A, and may include a plurality of sequential feature values 226 (e.g., f₁, f₂, f₃, f₄, . . . ) generated by executed training input module 208. Executed training input module 208 may perform operations, consistent with the Boruta feature-selection process, that permute or shuffle each of sequential feature values 226 and generate a corresponding set of shadow feature values 228 (e.g., s₁, s₂, s₃, s₄, . . . ), which executed training input module 208 may append to sequential feature values 226 within training dataset 224A. Further, although not illustrated in FIG. 2A, executed training input module 208 may perform similar operation to generate a set of shadow feature values based on a permutation or shuffling of the sequential feature values within each additional, or alternate, one of initial training datasets 224, and to append a corresponding one generated sets of shadow feature values to the sequential feature values within each of the additional, or alternate, ones of initial training datasets 224.

Executed training input module 208 may provide initial training datasets 224 (including the corresponding sets of shadow feature values) and ground-truth labels 218 as inputs to an adaptive training module 230 of executed training engine 202, which may perform operations that train adaptively the machine-learning or artificial-intelligence process (e.g., the gradient-boosted, decision-tree process described herein) against the elements of training data included within each of initial training datasets 224 and corresponding ground-truth labels 218. For example, upon execution by the one or more processors of FI computing system 130, adaptive training module 230 may perform operations that establish a plurality of nodes and a plurality of decision trees for the gradient-boosted, decision-tree process (i.e., in accordance with an initial set of process parameters), which may ingest and process the elements of training data maintained within each of the plurality of initial training datasets 224. Further, and based on the execution of adaptive training module 230, and on the ingestion of each of initial training datasets 224 by the established nodes of the gradient-boosted, decision-tree process, FI computing system 130 may perform operations that adaptively train the gradient-boosted, decision-tree process against the elements of training data included within each of initial training datasets 224 and corresponding ground-truth labels 218.

In some instances, the distributed components of FI computing system 130 may execute adaptive training module 230, and may perform any of the exemplary processes described herein in parallel to train adaptively the machine-learning or artificial-intelligence process (e.g., the gradient-boosted, decision-tree process described herein) against the elements of training data included within each of initial training datasets 224 and corresponding ground-truth labels 218. The parallel implementation of adaptive training module 230 by the distributed components of FI computing system 130 may, in some instances, be based on an implementation, across the distributed components, of one or more of the parallelized, fault-tolerant distributed computing and analytical protocols described herein (e.g., the Apache Spark™ distributed, cluster-computing framework).

Further, and through the performance of these adaptive training processes, executed adaptive training module 230 may perform operations that iteratively add, subtract, or combine discrete features from initial training datasets 224. For example, and through an implementation of the adaptive and dynamic feature selection processes described herein (e.g., the Boruta feature-selection process, etc.), executed adaptive training module 230 may perform operations that train adaptively the machine-learning or artificial-intelligence process (e.g., the gradient-boosted, decision-tree process described herein) using initial training datasets 224 that include, among other things, corresponding sets of sequential feature values (e.g., sequential feature values 226 of training dataset 224A) and corresponding sets of shadow feature values (e.g., sequential shadow feature 228 of training dataset 224A). Executed adaptive training module 230 may perform operations that compute a value of one or more metrics, such as a Shapley value, that characterize a relative importance of each of the features and shadow features of initial training datasets 224, and store the computed Shapley features for the features and shadow features within a portion of the one or more tangible, non-transitory memories of FI computing system 130.

In some examples, executed adaptive training module 230 may repeat these exemplary processes for training adaptively the machine-learning or artificial-intelligence process (e.g., the gradient-boosted, decision-tree process described herein) using initial training datasets 224 that include the corresponding sets of sequential feature values and shadow feature values, and for computing and storing Shapley values characterizing the relative importance of each of the features and shadow features of initial training datasets 224, a threshold or predetermined number of times (e.g., fifty times, 100 times, etc.) to, among other things, eliminate potential noise within the computed Shapley values. Executed adaptive training module 230 may access the computed feature- and shadow-feature-specific Shapley values associated with the repeated adaptive training processes, and compute, for each of the features and shadow features, an average Shapley value across the repeated adaptive training processes.

Executed adaptive training module 230 may, for example, determine a maximum of the average Shapley feature values characterizing the shadow features, and may determine that a first subset of the sequential features of initial training dataset 224 are associated with average Shapley values that are equivalent to, or that exceed, the maximum of the average Shapley feature values characterizing the shadow features, and that a second subset of the sequential features of initial training dataset 224 are associated with average Shapley values that fail to exceed the maximum of the average Shapley feature values characterizing the shadow features. In some instances, executed adaptive training module 230 may generate intermediate training datasets that include values of the first subset of the sequential features of initial training dataset 224, but that exclude the second subset of the sequential. For each of the intermediate training datasets, adaptive training module 230 may perform iterative operations, described herein, to generate a set of shadow feature values associated with the values of the first subset of the sequential features, and may perform iteratively any of the exemplary processes described herein to train adaptively the machine-learning or artificial-intelligence process (e.g., the gradient-boosted, decision-tree process described herein) using intermediate training datasets that include the corresponding sets of sequential feature values and shadow feature values across a plurality of repetitive training cycles (e.g., to eliminate noise, etc.), to identify a subset of the sequential features of the intermediate datasets associated with average Shapley values that are equivalent to, or exceed, a maximum of the average Shapley values characterizing the shadow features, and to generate one or more additional, intermediate training datasets that include the identified subset of sequential features.

In some instance, executed adaptive training module 230 may perform these iterative processes until the average Shapley values characterizing a final set of sequential features each exceed the corresponding maximum of the average Shapley values characterizing the shadow feature (and additionally, or alternatively, until the final set of sequential features includes a threshold, or minimum, number of features). Executed adaptive training module 230 may, for example, generate elements of candidate composition data 232 that identify each of the sequential features within the final set and their sequential positions within a corresponding input dataset. Executed adaptive training module 230 may also perform operations that compute one or more candidate process parameters that characterize the adaptively trained machine-learning or artificial-intelligence process (e.g., the gradient-boosted, decision-tree process described herein), and package the candidate process parameters into corresponding portions of candidate process data 234. In some instances, the candidate process parameters included within candidate process data 234 may include, but are not limited to, a learning rate associated with the adaptively trained, gradient-boosted, decision-tree process, a number of discrete decision trees included within the adaptively trained, gradient-boosted, decision-tree process (e.g., the “n_estimator” for the adaptively trained, gradient-boosted, decision-tree process), a tree depth characterizing a depth of each of the discrete decision trees included within the adaptively trained, gradient-boosted, decision-tree process, and/or a minimum number of observations in terminal nodes of the decision trees.

As illustrated in FIG. 2A, executed adaptive training module 230 may provide candidate composition data 232 and candidate process data 234 as inputs to executed training input module 208, which, in conjunction with executed adaptive training module 230, may perform operations that cross-validate the trained machine-learning or artificial-intelligence process (e.g., the trained gradient-boosted, decision-tree process described herein) against data maintained within the data records of validation fold 210B. For example, executed training input module 208 may receive candidate composition data 232, and may perform any of the exemplary processes described herein to generate a plurality of validation datasets 236 based on the corresponding ones of the data records of validation fold 210B, and in some instances, based on previously ingested elements of customer profile, account, transaction, or credit-bureau data that characterize one or more applicants involved in the corresponding applications for the unsecured lending products. As described herein, a composition, and a sequential ordering, of features values within each of validation datasets 236 may be consistent with the composition and corresponding sequential ordering set forth in candidate composition data 232, and each of validation datasets 236 may be associated with a corresponding one of ground-truth labels 220, as described herein. Further, an in addition to a corresponding set of sequential feature values, one or more of validation datasets 236 may also include a set of shadow feature values, which executed training input module 208 may generate using any of the exemplary processes described herein. Examples of these feature values include, but are not limited to, one or more of the feature values extracted, obtained, computed, determined, or derived by executed training input module 208 and packaged into corresponding potions of initial training datasets 224.

Executed training input module 208 may provide the plurality of validation datasets 236 and corresponding ground-truth labels 220 as inputs to executed adaptive training module 230, which may perform any of the exemplary processes described herein to apply the adaptively trained, machine-learning or artificial-intelligence process to the elements of validation data maintained within respective ones of validation datasets 236. By way of example, executed adaptive training module 230 may obtain candidate process data 234 from pre-processed data store 141, and may perform operations that establish the plurality of nodes and the plurality of decision trees for the adaptively trained, gradient-boosted, decision-tree process in accordance with each, or a subset, of candidate process data 234, and that apply the adaptively trained, gradient-boosted, decision-tree process to the elements of validation data maintained within validation datasets 236, e.g., based on an ingestion and processing of the data maintained within respective ones of validation datasets 236 by the established nodes and decision trees of the adaptively trained, gradient-boosted, decision-tree process. Further, executed adaptive training module 230 may also perform operations that generate elements of output data through the application of the adaptively trained, machine-learning or artificial-intelligence process (e.g., the adaptively trained, gradient-boosted, decision-tree process described herein) to corresponding ones of validation datasets 236, and in some instances, each of elements of output data may characterize a predict a likelihood of an occurrence, or a non-occurrence, of the one or more targeted events involving an unsecured lending product (e.g., a credit-card account, etc.) associated with a corresponding application during the future temporal interval.

Executed adaptive training module 230 may also perform operations that compute a value of one or more metrics that characterize a predictive capability, and an accuracy, of the adaptively trained, machine-learning or artificial-intelligence process based on the generated elements of output data, corresponding ones of validation datasets 236, and corresponding ones of ground-truth labels 220. The computed metrics may include, but are not limited to, one or more recall-based values for the adaptively trained, gradient-boosted, decision-tree process (e.g., “recall@5,” “recall@10,” “recall@20,” etc.), and additionally, or alternatively, one or more precision-based values for the adaptively trained, gradient-boosted, decision-tree process. Further, in some examples, the computed metrics may include a computed value of an area under curve (AUC) for a precision-recall (PR) curve associated with the adaptively trained, gradient-boosted, decision-tree process, a computed value of an AUC for a receiver operating characteristic (ROC) curve associated with the adaptively trained, gradient-boosted, decision-tree process, and additionally, or alternatively, a computed value of multiclass, one-versus-all area under curve (MAUC) for a ROC. The disclosed embodiments are, however, not limited to these exemplary computed metric values, and in other instances, executed adaptive training module 230 may compute a value of any additional, or alternate, metric appropriate to validation datasets 236, the ground-truth labels 220, or the adaptively trained, gradient-boosted, decision-tree process.

In some examples, executed adaptive training module 230 may also perform operations that determine whether all, or a selected portion of, the computed metric values satisfy one or more threshold validation conditions. For instance, the threshold validation conditions may specify one or more predetermined threshold values for the adaptively trained, gradient-boosted, decision-tree mode, such as, but not limited to, predetermined threshold values for the computed recall-based values, the computed precision-based values, and/or the computed AUC or MAUC values. In some examples, executed adaptive training module 230 that establish whether one, or more, of the computed recall-based values, the computed precision-based values, or the computed AUC or MAUC values exceed, or fall below, a corresponding one of the predetermined threshold values and as such, whether the adaptively trained, gradient-boosted, decision-tree process satisfies the threshold validation conditions.

If, for example, executed adaptive training module 230 were to establish that one, or more, of the computed metric values fail to satisfy at least one of the threshold validation conditions, FI computing system 130 may establish that the adaptively trained, gradient-boosted, decision-tree process is insufficiently accurate for a real-time application to the elements of customer profile, account, transaction, credit-bureau, and/or application data described herein. Executed adaptive training module 230 may perform operations (not illustrated in FIG. 2A) that transmit data indicative of the established inaccuracy to executed training input module 208, which may perform any of the exemplary processes described herein to generate one or more additional training datasets and corresponding ground-truth labels, which may be provisioned to executed adaptive training module 230. In some instances, executed adaptive training module 230 may receive the additional training datasets and corresponding ground-truth labels, and may perform any of the exemplary processes described herein to train further the gradient-boosted, decision-tree process against the elements of training data included within each of the additional training datasets.

Alternatively, if executed adaptive training module 230 were to establish that each computed metric value satisfies the threshold validation conditions, executed adaptive training module 230 may generate first composition data 238, which characterizes a composition of an input dataset for the adaptively trained, machine-learning or artificial-intelligence process, and identifies each of the discrete feature values within the input dataset, along with a sequence or position of these feature values within the input dataset. Executed adaptive training module 230 may also generate elements of first process data 340 that include the one or more process parameters of the adaptively trained, machine-learning or artificial-intelligence process, such as, but not limited to, one or more of the process parameters specified within candidate process data 234. Further, executed adaptive training module 230 may also perform any of the exemplary processes descried herein to generate elements of explainability data 242 that characterize a relative importance of one or more of the feature values of the input dataset for the adaptively trained machine-learning or artificial-intelligence process, such as, but not limited to, a raw or averaged Shapley value characterizing each of the feature values of the input dataset. As illustrated in FIG. 2A, executed adaptive training module 230 may perform operations that store first composition data 238, first process data 240, and explainability data 242 within a locally or remotely accessible data repository, such as within pre-processed data store 141.

As described herein, while the data records associated with first population 144 identify and characterize approved and funded applications, the data records associated with second population 146 identify and characterize rejected applications for unsecured lending products, or alternatively, approved, but unfunded, applications for unsecured lending products. Due to the rejected status, or the approved but unfunded status, of each of these applications, aggregated data store 132 may not maintain any elements of account or transaction data characterizing the unsecured lending products associated with these rejected, or approved but unfunded, applications and in some instances, certain of the exemplary ground-truth labelling processes described herein may be incapable or assigning directly ground-truth labels to additional training, validation, or testing subsets associated with these rejected, or approved but unfunded, applications. In some examples, based on the inability to assign directly outcome labels these additional training, validation, or testing subsets, FI computing system 130 may perform operations that assign a ground-truth label to the rejected, or approved but unfunded, applications associated with the data records of second population 146 based on an application, consistent with first process data 240, of the adaptively trained, machine-learning or artificial-intelligence process to input datasets associated with the data records of second population 146 and having compositions consistent with first composition data 238.

In some examples, processes that label the rejected, or approved but unfunded, applications characterized by second population 146 based on the application of a machine-learning or artificial-intelligence process trained adaptively using training and validation datasets associated with the approved and funded applications characterized by first population 144 may introduce a bias towards an adjudication strategy currently or previously applied by the financial institution to applications for unsecured lending products. In further examples, to substantially reduce, or eliminate, such bias, FI computing system 130 may perform operations that infer an appropriate for one or more ground-truth label for each, or a subset, of the rejected, or approved but unfunded applications, characterized by second population 146 based on an application of a rules-based inferencing process to data, such as batch credit-bureau data, characterizing an applicant (or applicants) involved in corresponding ones of the rejected, or approved but unfunded, applications. The rules-based inferencing process may, for example, be informed by explainability data characterizing a prior adaptive training of a machine-learning or artificial-intelligence process using corresponding training and validation datasets extracted from temporally distinct subsets of the preprocessed data records of first population 144, such as, but not limited to, the elements of explainability data 242 characterizing the relative importance of each of the feature values specified within first composition data 238

Referring to FIG. 2C, executed training input module 208 of executed training engine 202 may perform operations that access the data records of second population 146, e.g., as maintained in pre-processed data store 141. Based on portions of splitting data 206, executed training input module 208 may determine that: (i) a subset 244 of these data records are associated with rejected, or approved but unfunded, applications having decisions dates disposed within the in-time training interval Δt_{training}, and as such, may be appropriate to train adaptively and validate the gradient-boosted decision model during the in-time training interval; and (ii) a subset 246 of these data records are associated with rejected, or approved but unfunded, applications having decision dates disposed within the out-of-time testing interval Δt_{testing}, and as such, may be appropriate to testing the adaptively trained and validated gradient-boosted decision model on previously unseen data prior to deployment. Executed training input module 208 may also perform any of the exemplary processes described herein to partition subset 244 of the data records into one or more partitions or folds that facilitate the adaptive training the machine-learning or artificial-intelligence process (e.g., the gradient-boosted, decision-tree process described herein) during the in-time training interval Δt_{training}, such as, but not limited to training fold 244A, and one or more partitions or folds that facilitate a cross-validation of the adaptively trained machine-learning or artificial-intelligence process during the in-time training and interval Δt_{training}, such as, but not limited to, validation fold 244B.

In some examples, a ground-truth inferencing engine 248 executed by the one or more processors of FI computing system 130 may perform operations that determine, or “infer,” an appropriate ground-truth for each of the rejected, or approved but unfunded, applications characterized by the data records of training subset 244 (including training fold 244A and validation fold 244B) and testing subset 246 based on an application of the rules-based inferencing process to previously ingested elements of data, such credit-bureau data, characterizing and each applicant involved in corresponding ones of the rejected, or approved but unfunded, applications. As illustrated in FIG. 2C, executed ground-truth inferencing engine 248 may access pre-processed data store 141 and obtain the elements of first composition data 238, which identifies each of the feature values of an input dataset associated with a machine-learning or artificial-intelligence process trained previously using the data records of first population 144, and elements of explainability data 242, which includes the Shapley values characterizes the relative importance of each of the feature values on the predictive output of the previously trained machine-learning or artificial-intelligence process.

Executed ground-truth inferencing engine 248 may also perform operations that, based on the corresponding Shapley values, identify a subset of the features that contribute to the predictive output of the previously trained machine-learning or artificial-intelligence process, such as, but not limited to, those features associated with corresponding Shapley values that exceed a predetermined threshold value, or a predetermined number of feature characterized by Shapley values of the largest magnitude. The identified features may, for example, correspond to occurrences of one or more events (e.g., “inferential” events) involving existing customers of the financial institution, such as, but limited to, an occurrence of a write-off or other negative treatment of a financial services account or an occurrence of a delinquency event of at least a threshold duration, such as, but not limited to, thirty days, sixty days, ninety days, or 120 days. In some instances, executed ground-truth inferencing engine 248 may establish a rubric for inferring an appropriate ground-truth label for a corresponding one of the rejected, or approved but unfunded, applications based on a determined occurrence, or non-occurrence, of the one or more inferential events involving an applicant associated with the corresponding application during a temporal interval disposed subsequent to a decision date of the corresponding application, e.g., a twelve-month temporal interval disposed between six and eighteen months subsequent to the decision date.

By way of example, executed ground-truth inferencing engine 248 may access data record 146A, which may be allocated to training fold 244A of training subset 244. As described herein, data record 146A may characterize a rejected application for a credit-card account involving a single applicant (e.g., associated with applicant identifier 162 of FIG. 1) and associated with a decision date of May 1, 2023 (e.g., as specified within the elements of temporal data 166). In some instances, executed ground-truth inferencing engine 248 may obtain applicant identifier 162 of the single applicant and temporal data 166, which specifies the May 1^{st} decision date of the rejected application, and that access one or more previously ingested elements 250 of batch credit-bureau data that include, or reference, applicant identifier 162, e.g., as maintained by aggregated data store 132 of FI computing system 130. Further, and based on previously ingested elements 250 of batch credit-bureau data, executed ground-truth inferencing engine 248 may perform operations that establish an occurrence, or a non-occurrence, of the one or more inferential events involving the single applicant associated with the rejected application during the temporal interval disposed subsequent to May 1, 2023, decision date of the rejected application.

As described herein, the temporal interval may correspond to a twelve-month temporal interval disposed between six and eighteen months subsequent to the decision date of the rejected application, e.g., a twelve-month interval disposed between Nov. 1, 2023, and Nov. 1, 2024, and the one or more events may include an occurrence of a write-off or other negative treatment involving a financial services account held by the single applicant, or an occurrence of a delinquency event involving the single applicant of at least a threshold duration (e.g., thirty days, sixty days, ninety days, 120 days, etc.). In some instances, and based on previously ingested elements 250 of batch credit-bureau data, executed ground-truth inferencing engine 248 may perform operations that establish either (i) an occurrence of the write-off or other negative treatment involving the financial services account held by the single applicant between Nov. 1, 2023, and Nov. 1, 2024, or (ii) an occurrence of the delinquency event involving the single applicant of at least the threshold duration between Nov. 1, 2023, and Nov. 1, 2024.

If, for example, executed ground-truth inferencing engine 248 were to establish the occurrence of neither the write-off or other negative treatment, nor the delinquency event involving of at least the threshold duration, between Nov. 1, 2023, and Nov. 1, 2024, executed ground-truth inferencing engine 248 may infer that the rejected application, if approved by the financial institution, would be associated with an inferred positive outcome, and may generate a corresponding one of inferred ground-truth labels 252, such as inferred label 252A, that associates the corresponding, rejected application within the inferred positive outcome (e.g., as a positive target for the adaptive training processes described herein). Alternatively, if executed ground-truth inferencing engine 248 were to establish the occurrence of at least one of the write-off or other derogatory treatment and the delinquency event involving of at least the threshold duration between Nov. 1, 2023, and Nov. 1, 2024, executed ground-truth inferencing engine 248 may infer that the rejected application, if approved by the financial institution, would be associated with an inferred negative outcome, and may generate a corresponding one of inferred ground-truth labels 252 that associates the corresponding, rejected application within the inferred negative outcome (e.g., as a negative target for the adaptive training processes described herein).

Executed ground-truth inferencing engine 248 may perform any of the exemplary processes described herein to determine or infer a corresponding one of assigned ground-truth labels 218 for each additional, or alternate, data record of training fold 244A of training subset 244. Further, executed ground-truth inferencing engine 248 may perform any of the exemplary processes described herein to determine or infer a corresponding one of inferred ground-truth labels 254 for each of the data records maintained within validation fold 244B of training subset 244, and to determine or infer a corresponding one of inferred ground-truth labels 256 for each of the data records maintained within testing subset 246. As illustrated in FIG. 2C, executed ground-truth inferencing engine 248 may perform operations that store inferred ground-truth labels 252, 254, and 256 in corresponding portions of pre-processed data store 141, e.g., in conjunction or association with respective ones of training fold 244A and validation fold 244B of training subset 244 and testing subset 246.

As illustrated in FIG. 2C, executed training input module 208 may perform any of the exemplary processes described herein that generate one or more initial training datasets 258 based on the data records allocated to training fold 244A, and additionally, or alternatively, based on elements of ingested customer profile, account, transaction, or credit-bureau data maintained within the one or more tangible, non-transitory memories of FI computing system 130 (e.g., within aggregated data store 132). As described herein, each of initial training datasets 258 may be associated with a corresponding one of the rejected applications, or the approved but unfunded, applications for the unsecured lending products (e.g., a credit-card account, as described herein) that is characterized by a decision date disposed within disposed within the training interval Δt_{training}, and further, that is associated with a corresponding one of inferred ground-truth labels 252 (e.g., as determined by executed ground-truth inferencing engine 248 using any of the exemplary processes described herein). In some instances, the plurality of initial training datasets 258 may, when provisioned to an input layer of the gradient-boosted decision-tree process described herein in conjunction with corresponding ones of the ground-truth labels 218, enable executed training engine 202 to train adaptively the gradient-boosted decision-tree process to predict a likelihood of an occurrence, or a non-occurrence, of one or more targeted events involving an unsecured lending product associated with a corresponding application during a future temporal interval, e.g., in real-time and on-demand upon receipt from a corresponding digital channel.

As described herein, each of initial training datasets 224 may include, among other things, an application identifier associated with that corresponding one of the rejected, or approved but unfunded, application, an applicant identifier of a corresponding applicant (or applicants), and temporal data characterizing the corresponding decision date. Further, each of initial training datasets 224 may also include sequentially ordered elements of data (e.g., feature values) that characterize the corresponding application for the unsecured lending product and additionally, or alternatively, the applicant (or applicants) involved in the corresponding application, which executed training input module 208 may obtain or extract from, or compute, determine, or derive based on, portions of the data records allocated to training fold 244A and associated with corresponding ones of the rejected, or approved but unfunded, applications, and additionally, or alternatively, from previously ingested elements of ingested customer profile, account, transaction, or credit-bureau data associated with the corresponding applicant or applicants, using any of the exemplary processes described herein.

Examples of these obtained or extracted feature values, and of these computed, determined, or derived feature values, may include one or more of the exemplary feature values described herein, e.g., in reference to initial training datasets 224. Further, executed training input module 208 may any of the exemplary processes described herein to permute or “shuffle” (e.g., randomly or pseudo-randomly) the sequentially ordered feature values maintained within one, or more of, initial training datasets 258 (e.g., in accordance with a Boruta feature-selection process), and to generate a corresponding sequence of “shadow” feature values and append each of the generated sequences of shadow feature values to the sequentially ordered feature values maintained within corresponding ones of initial training datasets 258.

Executed training input module 208 may provide initial training datasets 258 (including the corresponding sets of sequentially ordered feature values and appended shadow feature values) and inferred ground-truth labels 252 as inputs to executed adaptive training module 230, which may perform any of the exemplary processes described herein to further train adaptively the machine-learning or artificial-intelligence process (e.g., the gradient-boosted, decision-tree process described herein) against additional elements of training data included within each of initial training datasets 258, which are associated with the rejected, or approved but unfunded, applications for the unsecured lending products characterized by second population 146, and corresponding assigned ground-truth labels 218, which may be determined or inferred by executed ground-truth inferencing engine using any of the exemplary processes described herein. For example, executed adaptive training module 230 may perform operations that establish a plurality of nodes and a plurality of decision trees for the gradient-boosted, decision-tree process (i.e., in accordance with an initial set of process parameters), which may ingest and process the additional elements of training data maintained within each of the plurality of initial training datasets 258. Further, and based on the execution of adaptive training module 230, and on the ingestion of each of initial training datasets 224 by the established nodes of the gradient-boosted, decision-tree process, FI computing system 130 the exemplary processes described herein to train adaptively the gradient-boosted, decision-tree process against the elements of training data included within each of initial training datasets 258 and corresponding ones of assigned ground-truth labels 218, and compute a value of one or more metrics, such as a Shapley value, that characterize a relative importance of discrete feature values, and shuffled feature values and within one or more of initial training datasets 258.

Further, and through the performance of these adaptive training processes, executed adaptive training module 230 may perform operations, described herein, that iteratively add, subtract, or combine discrete features from initial training datasets 258 based on, among other things, the corresponding Shapley values or averages of these Shapley values computed across multiple, successive training processes. For example, and through an implementation of the adaptive and dynamic feature selection processes described herein (e.g., the Boruta feature-selection process, etc.), executed adaptive training module 230 may perform operations (e.g., in accordance with a Boruta feature selection process) that identify, within one or more current training dataset (e.g., initial training datasets 258), a subset of the sequential features characterized by average Shapley values that fail to exceed a maximum of the average Shapley values characterizing the shadow features, and to generate one or more additional, intermediate training datasets that exclude the identified subset of sequential features, and that further adaptive train the machine-learning or artificial-intelligence process (e.g. the gradient-boosted, decision-tree process described herein) against elements of training data maintained within the one or more intermediate training datasets and corresponding ones of inferred ground-truth labels. In some instances, executed adaptive training module 230 may perform iteratively one or more of these exemplary adaptive training processes, including the exemplary adaptive and dynamic feature-selection processes described herein (e.g., in accordance with a Boruta feature-selection process) until average Shapley values characterizing a final set of sequential features each exceed a corresponding maximum of the average Shapley values characterizing the shadow features (and additionally, or alternatively, until the final set of sequential features includes a threshold, or minimum, number of features).

In some instances, adaptive training module 230 may generate elements of candidate composition data 260 that identify each of the sequential features within the final set and their sequential positions within a corresponding input dataset. Executed adaptive training module 230 may also perform any of the exemplary processes described herein to compute one or more candidate process parameters that characterize the adaptively trained machine-learning or artificial-intelligence process (e.g., the gradient-boosted, decision-tree process described herein), and package the candidate process parameters into corresponding portions of candidate process data 262. In some instances, the candidate process parameters included within candidate process data 262 may include, but are not limited to, one or more of the exemplary process parameters described herein. As illustrated in FIG. 2C, executed adaptive training module 230 may provide candidate composition data 260 and candidate process data 262 as inputs to executed training input module 208, which, in conjunction with executed adaptive training module 230, may one or more of the exemplary processes described herein to cross-validate the further trained machine-learning or artificial-intelligence process (e.g., the further trained gradient-boosted, decision-tree process described herein) against elements of validation data maintained within the data records of validation fold 210B.

For example, executed training input module 208 may receive candidate process data 262, and may perform any of them exemplary processes described herein to generate a plurality of validation datasets 264 based on the corresponding ones of the data records of validation fold 210B of training subset 210, and in some instances, based on previously ingested elements of customer profile, account, transaction, or credit-bureau data that characterize one or more applicants involved in the corresponding ones of the rejected, or approved but unfunded, applications for the unsecured lending products. As described herein, a composition, and a sequential ordering, of features values within each of validation datasets 264 may be consistent with the composition and corresponding sequential ordering set forth in candidate composition data 260, and each of validation datasets 264 may be associated with a corresponding one of inferred ground-truth labels 254, which executed ground-truth inferencing engine 248 may generate using any of the exemplary processes described herein, Further, and in addition to a corresponding set of sequential feature values, one or more of validation datasets 264 may also include a set of shadow feature values, which executed training input module 208 may generate using any of the exemplary processes described herein. Examples of these feature values include, but are not limited to, one or more of the feature values extracted, obtained, computed, determined, or derived by executed training input module 208 and packaged into corresponding potions of initial training datasets 258.

As described herein, the plurality of validation datasets 312 and ground-truth labels 220 may, when provisioned to, and ingested by, the nodes of the decision trees of the adaptively trained, gradient-boosted, decision-tree process (e.g., established in accordance with candidate process data 262), enable executed training engine 202 to validate the predictive capability and accuracy of the adaptively trained, gradient-boosted, decision-tree process, for example, based on inferred ground-truth labels 254 associated with corresponding ones of the validation datasets 264, and based on one or more computed metrics values, such as, but not limited to, computed precision values, computed recall values, computed areas under curve (AUCs) for receiver operating characteristic (ROC) curves or precision-recall (PR) curves, and/or computed multiclass, one-versus-all areas under curve (MAUCs) for ROC curves.

Referring back to FIG. 2C, executed training input module 208 may provide the plurality of validation datasets 264 and corresponding inferred ground-truth labels 254 as inputs to executed adaptive training module 230, which may obtain candidate process data 262 from pre-processed data store 141, and may perform operations that establish the plurality of nodes and the plurality of decision trees for the gradient-boosted, decision-tree process in accordance with each, or a subset, of candidate process data 262. Executed adaptive training module 230 may perform any of the exemplary processes described herein to apply the adaptively trained, gradient-boosted, decision-tree process to the elements of validation data maintained within respective ones of validation datasets 264, e.g., based on an ingestion and processing of the data maintained within respective ones of validation datasets 264 by the established nodes and decision trees of the adaptively trained, gradient-boosted, decision-tree process. Further, and through the application of the adaptively trained, gradient-boosted, decision-tree process to corresponding ones of validation datasets 264, executed adaptive training module 230 may also perform operations that generate elements of output data characterizing a predicted likelihood of an occurrence, or a non-occurrence, of one or more targeted events involving an unsecured lending product (e.g., a credit-card account, etc.) associated with a corresponding application during a future temporal interval.

Executed adaptive training module 230 may also perform any of the exemplary processes described herein to compute a value of one or more metrics that characterize a predictive capability, and an accuracy, of the adaptively trained, gradient-boosted, decision-tree process based on the generated elements of output data, corresponding ones of validation datasets 236, and corresponding ones of ground-truth labels 220, and to determine whether all, or a selected portion of, the computed metric values satisfy one or more threshold validations conditions. The computed metric values may include, but are not limited to, one or more of the exemplary metric values characterizing the predictive capability, and the accuracy adaptively trained, gradient-boosted, decision-tree process, as described herein, and the threshold validation condition may include, but are not limited to, one or more of the exemplary, predetermined threshold values described herein.

If, for example, executed adaptive training module 230 were to establish that one, or more, of the computed metric values fail to satisfy at least one of the threshold validation conditions, FI computing system 130 may establish that the further trained machine-learning or artificial-intelligence process is insufficiently accurate for deployment, and executed adaptive training module 230 may perform operations (not illustrated in FIG. 2C) that transmit data indicative of the established inaccuracy to executed training input module 208, which may perform any of the exemplary processes described herein to generate one or more additional training datasets and corresponding ground-truth labels, which may be provisioned to executed adaptive training module 230. In some instances, executed adaptive training module 230 may receive the additional training datasets and corresponding ground-truth labels, and may perform any of the exemplary processes described herein to train further the gradient-boosted, decision-tree process against the elements of training data included within each of the additional training datasets.

Alternatively, if executed adaptive training module 230 were to establish that each computed metric value satisfies each of the threshold validation conditions, executed adaptive training module 230 may generate second composition data 266, which characterizes a composition of an input dataset for the adaptively trained, and now cross-validated, machine-learning or artificial-intelligence process (e.g., the further trained gradient-boosted, decision-tree process described herein), and identifies each of the feature values within the input dataset, along with a sequence or position of these feature values within the input dataset. Executed adaptive training module 230 may also generate elements of second process data 268 that include the one or more process parameters of the adaptively trained, gradient-boosted, decision-tree process, such as, but not limited to, one or more of the exemplary process parameters described herein. Further, executed adaptive training module 230 may also perform any of the exemplary processes descried herein to generate elements of explainability data 270 that characterize a relative importance of one or more of the feature values of the input dataset for the adaptively trained, and now validated, gradient-boosted, decision-tree process, such as, but not limited to, a raw or averaged Shapley value characterizing each of the feature values of the input dataset. As illustrated in FIG. 2C, executed adaptive training module 230 may perform operations that store second composition data 266, second process data 268, and explainability data 270 within a locally or remotely accessible data repository, such as pre-processed data store 141.

Through an implementation of one or more of the exemplary processes described herein, FI computing system 130 may adaptively train and cross-validate a machine-learning or artificial-intelligence process (e.g., an ensemble-based, gradient-boosted, decision-tree process, as described herein) using corresponding training and validation datasets characterizing a first population of approved, and funded, applications for unsecured lending products and based on corresponding ground-truth labels that reflect an actual use (or misuse) of corresponding ones of the unsecured lending products by an applicant. Further, and based on elements of first composition data that identify a plurality of first sequential features and their positions within a corresponding input dataset associated with the initially trained machine-learning or artificial-intelligence process, and based on elements of explainability data that characterize a relative importance of each of first sequential features to a predictive output of the initially trained machine-learning or artificial-intelligence process, FI computing system 130 may perform any of the exemplary processes described herein to determine, or “infer,” ground-truth labels for a second population of rejected, or approved but unfunded, applications for unsecured lending products based on an application of a rules-based inferencing process to data, such as batch credit-bureau data, characterizing a corresponding applicant (or corresponding applicants). FI computing system 130 may also perform any of the exemplary processes described herein to further train and cross-validate the machine-learning or artificial-intelligence process using corresponding training and validation datasets characterizing the second population of rejected, or approved but unfunded, and based on corresponding ones of the “inferred” ground-truth labels, and to generate elements of second composition data that identify second sequential features and their positions within a corresponding input dataset associated with the further trained machine-learning or artificial-intelligence process.

Certain of the exemplary processes described herein, when implemented by the distributed components of FI computing system 130, may facilitate a generation of a robust set of first sequential features associated with, and based on, first population 144 of the approved and funded applications for the unsecured credit products, and further, may facilitate a generation of a robust set of second sequential features associated with, and based on, second population 146 of the rejected, or approved but unfunded, applications for the unsecured credit products associated with corresponding, inferred ground-truth labels. In some examples, described herein, FI computing system 130 may also perform operations that generate an augmented set of sequential features based on a combination of the first features (e.g., associated with the labelled first population of the approved and funded applications) and the second features (e.g., associated with the second population of the rejected, or approved but unfunded, applications for the unsecured credit products associated with corresponding, inferred ground-truth labels). Further, and based on the augmented set of sequential features, FI computing system 130 may also perform any of the exemplary processes described herein to adaptively train, cross-validate, and test a machine-learning or artificial-intelligence process (e.g., a gradient-boosted, decision-tree process, as described herein) using corresponding training, validation, and testing datasets associated with, and characterizing, both the first population of the approved, and funded, applications for unsecured lending products (and corresponding assigned ground-truth labels) and the second population of the rejected, or approved but unfunded, applications for the unsecured credit products (and corresponding inferred ground-truth labels).

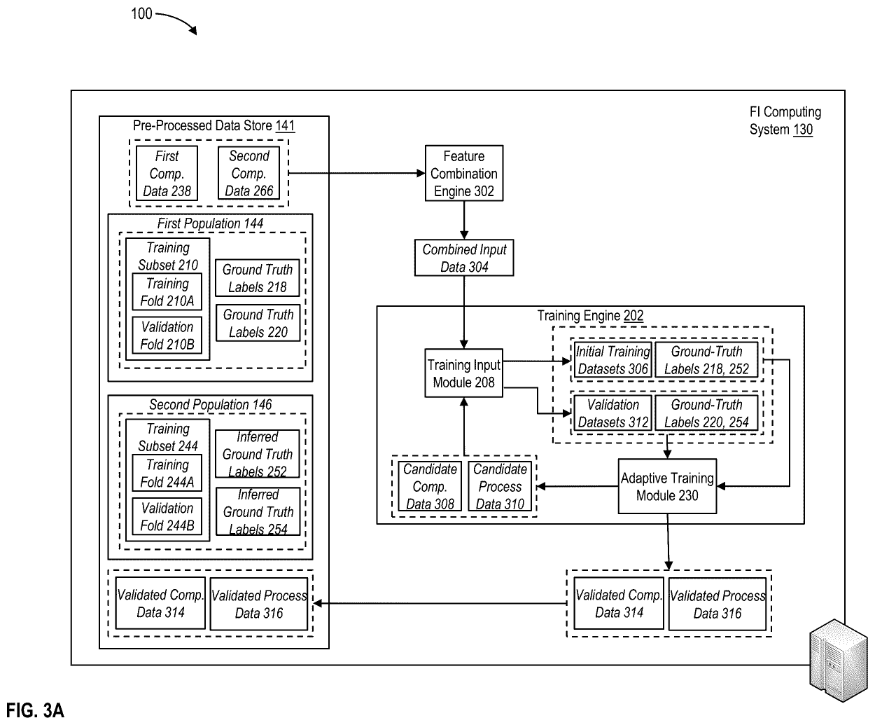

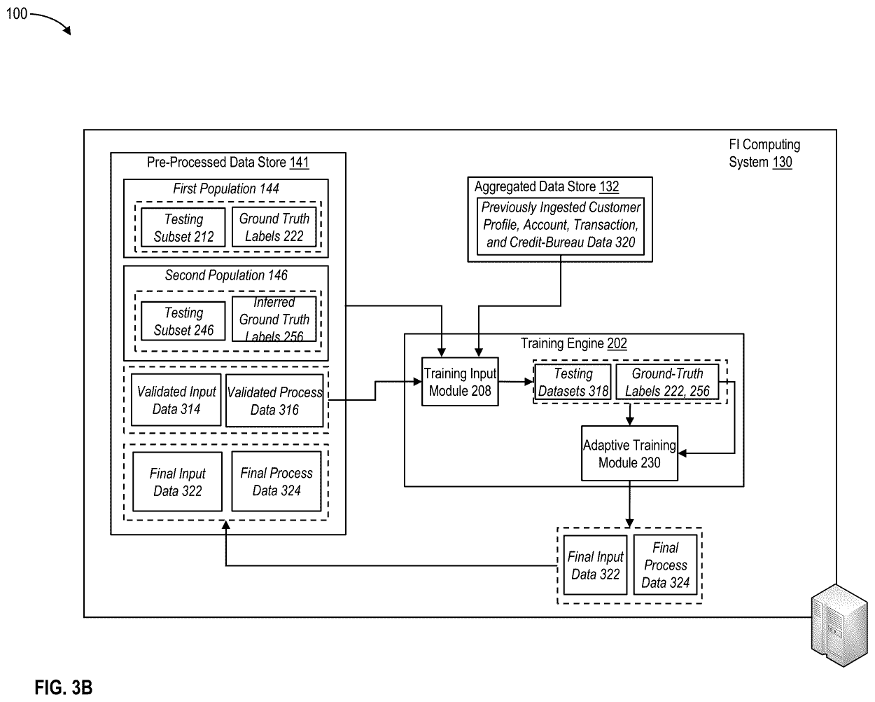

Referring to FIG. 3A, a feature combination engine 302 executed by the one or more processors of FI computing system 130 may access pre-processed data store 141, and obtain elements of first composition data 238 and second composition data 266. As described herein, the elements of first composition data 238 may identify the first sequential features of an input dataset for a machine-learning or artificial-intelligence process (e.g., the ensemble-based, gradient-boosted, decision-tree process, as described herein) adaptively trained and validated using corresponding datasets associated with first population 144 of the approved and funded applications for the unsecured credit products, and the elements of second composition data 266 may identify the second sequential features of an input dataset for a machine-learning or artificial-intelligence process adaptively trained and validated using corresponding datasets associated with second population 146 of the rejected, or approved but unfunded, applications for the unsecured credit products. In some instances, executed feature combination engine 302 may process each pair of the first and second sequential features, and generate elements of combined input data 304 that include a set of combined sequential features that include each, or a subset of, the first and second sequential features associated with respective ones of first composition data 238 and second composition data 266. For example, the elements of first composition data 238 may identify a set of first sequential features {f₁, f₃, f₄}, the elements of second composition data 266 may identify a set of second sequential features {f₁, f₂, f₅}, and executed feature combination engine 302 may generate the elements of combined input data 304 that include a combination of the first and second sequential features, e.g., {f₁, f₂, f₃, f₄, f₅}.

Further, in some instances, executed feature combination engine 302 may compute a correlation value that characterizes a mathematical or behavioral relationship between for each pair of the first and second sequential features within combined input data 304, and identify one, or more of the pairs of the first and second sequential features having a correlation value that exceeds a threshold value (and as such, represent highly correlated pairs of first and second sequential features). Further, and for each of the identified, highly correlated pairs of the first and second feature sequential values, executed feature combination engine 302 may perform operations that exclude a corresponding one of the first sequential feature, or second sequential feature, from the set of combined sequential features identified within combined input data 304. For example, executed feature combination engine 302 may perform any of the exemplary processes described herein to determine that a correlation value characterizing the pair of first and sequential features {f₃, f₂} exceeds the threshold value, and as such, that the pair of first and sequential features {f₃, f₂} represent a highly correlated pair of first and sequential features. Based on the correlation value characterizing the pair of first and sequential features {f₃, f₂}, and on correlation values characterizing other pairs of first and sequential features, executed feature combination engine 302 may exclude second sequential feature f₂ from the set of combined sequential features, an output elements of combined input data 304 that include augmented sequential features {f₁, f₃, f₄, f₅}.

Referring back to FIG. 3A, executed feature combination engine 302 may provide the elements of combined input data 304 as an input to executed training input module 208 of executed training engine 202. Further, and based on a receipt of the elements of combined input data 304, executed training input module 208 of executed training engine 202 may perform operations that access the data records of both first population 144 and second population 146, as maintained in pre-processed data store 141. As described herein, the data records of first population 144 characterize approved and funded applications for unsecured lending products involving a corresponding applicant (or applicant), and the data records of second population 146 characterize rejected, or approved but unfunded, applications for unsecured lending products involving a corresponding applicant (or applicant).

As illustrated in FIG. 3A, and as described herein, the data records of first population 144 may be partitioned into training subset 210, which includes those data records are associated with approved and funded applications having decisions dates disposed within the in-time training interval Δt_{training}, and testing subset 212, which includes those pre-processed data are associated with applications having final decision dates disposed within the out-of-time testing interval Δt_{testing}. Similarly, the data records of second population 146 may be partitioned into training subset 244, which includes those data records are associated with rejected, or approved but unfunded, applications having decisions dates disposed within the in-time training interval Δt_{training}, and testing subset 212, which includes those pre-processed data are associated with rejected, or approved but unfunded, applications having final decision dates disposed within the out-of-time testing interval Δt_{testing}.

Further, as described herein, the data records of training subset 210 may be decomposed into one or more partitions or folds that facilitate the adaptive training of the machine-learning or artificial-intelligence process (e.g., the gradient-boosted, decision-tree process described herein) during the in-time training and interval Δt_{training}, such as, but not limited to training fold 210A, and one or more partitions or folds that facilitate a cross-validation of the adaptively trained machine-learning or artificial-intelligence process during the in-time training and interval Δt_{training}, such as, but not limited to, validation fold 210B. Similarly, the data records of training subset 244 may also be decomposed into one or more partitions or folds that facilitate the adaptive training of the machine-learning or artificial-intelligence process during the in-time training and interval Δt_{training}, such as, but not limited to training fold 244A, and one or more partitions or folds that facilitate a cross-validation of the adaptively trained machine-learning or artificial-intelligence process during the in-time training and interval Δt_{training}, such as, but not limited to, validation fold 244B.

In some instances, executed training input module 208 may perform any of the exemplary processes described herein to generate one or more initial training datasets 306 based on the data records allocated to training fold 210A (e.g., associated with first population 144) and to training fold 244A (e.g., associated with second population 146), and additionally, or alternatively, based on elements of ingested customer profile, account, transaction, or credit-bureau data maintained within the one or more tangible, non-transitory memories of FI computing system 130 (e.g., within aggregated data store 132). Initial training datasets 306 may, for example, include a training dataset associated with each, or a subset, of the approved and funded applications for the unsecured lending products characterized by the data records of training fold 210A, and with a corresponding one of assigned ground-truth labels 218. Further, by way of example, initial training datasets 306 may also include a training dataset associated with each, or a subset, of the rejected, or approved but unfunded, applications for the unsecured lending products characterized by the data records of training fold 244A, and with a corresponding one of inferred ground-truth labels 252. In some instances, a composition, and a sequential ordering, of features values within each of validation datasets 236 may be consistent with the composition and corresponding sequential ordering set forth in combined input data 304 (e.g., the set of combined sequential features described herein)

Executed training input module 208 may provide initial training datasets 306, and corresponding ones of ground-truth labels 218 and inferred ground-truth labels 252, as inputs to executed adaptive training module 230, which may perform any of the exemplary processes described herein to train adaptively the machine-learning or artificial-intelligence process (e.g., the gradient-boosted, decision-tree process described herein) against additional elements of training data included within each of initial training datasets 306 and against corresponding ones of assigned ground-truth labels 218 and inferred ground-truth labels 252. For example, executed adaptive training module 230 may perform operations that establish a plurality of nodes and a plurality of decision trees for the gradient-boosted, decision-tree process (i.e., in accordance with an initial set of process parameters), which may ingest and process the additional elements of training data maintained within each of the plurality of initial training datasets 306. Further, and based on the execution of adaptive training module 230, and on the ingestion of each of initial training datasets 306 by the established nodes of the gradient-boosted, decision-tree process, FI computing system 130 the exemplary processes described herein to train adaptively the gradient-boosted, decision-tree process against the elements of training data included within each of initial training datasets 306 and corresponding ones of assigned ground-truth labels 218 and inferred ground-truth labels 252. Executed training input module 208 may perform any of the exemplary processes described herein to compute a value of one or more metrics, such as a Shapley value, that characterize a relative importance of each of the combined sequential features within one or more of initial training datasets 306 to a predictive output of the trained machine-learning or artificial-intelligence, e.g., the trained gradient-boosted, decision-tree process described herein.

Through the performance of these adaptive training processes, executed adaptive training module 230 may perform operations that iteratively add, subtract, or combine discrete features from initial training datasets 306 based on the corresponding Shapley values, and that generate one or more intermediate training datasets reflecting the iterative addition, subtraction, or combination of discrete features from corresponding ones of initial training datasets 306, and in some instances, an intermediate set of process parameters for the gradient-boosted, decision-tree process (e.g., to correct errors, etc.). For example, executed adaptive training module 230 may exclude, from the one or more intermediate training datasets, a corresponding one of the combined sequential features associated with a minimum of the computed Shapley values, a predetermined number of the combined sequential features characterized by the lowest of computed Shapley values, or any of the combined sequential features characterized by a corresponding one of the computed Shapley values disposed below a corresponding threshold value.

Executed adaptive training module 230 may also perform operations that re-establish the plurality of nodes and the plurality of decision trees for the gradient-boosted, decision-tree process (i.e., in accordance with the intermediate set of process parameters), which may ingest and process the elements of training data maintained within each of the intermediate training datasets. Based on the execution of adaptive training module 230, and on the ingestion of each of the intermediate training datasets by the re-established nodes of the gradient-boosted, decision-tree process, FI computing system 130 may perform operations that adaptively train the gradient-boosted, decision-tree process against the elements of training data included within each of intermediate training datasets and corresponding elements of ground-truth labels and further, that generate additional Shapley feature values that characterize a relative of importance of each feature within one or more of intermediate training datasets and/or a performance of the trained gradient-boosted, decision-tree process.

In some instances, executed adaptive training module 230 may implement iteratively one or more of the exemplary adaptive training processes described herein, which iteratively add, subtract, or combine discrete features from corresponding ones of intermediate training datasets based on the corresponding Shapley feature values or one or more of the generated values of the metrics, until a marginal impact resulting from a further addition, subtraction, or combination of discrete features values on a predictive output of the gradient-boosted, decision-tree process falls below a predetermined threshold (e.g., the addition, subtraction, or combination of the discrete features values within an updated intermediate training dataset results in a change in a value of one or more of the probabilistic metrics that falls below a predetermined threshold change, etc.). Based on the determination that the marginal impact resulting from the further addition, subtraction, or combination of discrete features values on the predictive output falls below the predetermined threshold, executed adaptive training module 230 may deem complete the training of the gradient-boosted, decision-tree process against initial training datasets 306, and may perform operations that generate candidate composition data 308 that specifies a composition of an input dataset for the adaptively trained, machine-learning or artificial intelligence process.

As described herein, candidate composition data 308 may identify each of a plurality of sequential features included within the input dataset, and a position or order of each sequential feature within the input dataset. Further, and as described herein, executed adaptive training module 230 may compute one or more candidate process parameters that characterize the adaptively trained, machine-learning or artificial intelligence process, and package the candidate process parameters into corresponding portions of candidate process data 310. In some instances, the candidate process parameters included within candidate process data 310 may include, but are not limited to, one or more of the process parameters described herein for the adaptively trained, gradient-boosted, decision-tree process

As illustrated in FIG. 3A, executed adaptive training module 230 may provide candidate composition data 308 and candidate process data 310 as inputs to executed training input module 208 of executed training engine 202, which, in conjunction with executed adaptive training module 230, may perform any of the exemplary processes described herein to cross-validate the trained machine-learning or artificial-intelligence process (e.g., the trained gradient-boosted, decision-tree process described herein) against portions of the data records allocated to validation fold 210B (e.g., associated with first population 144) and to validation fold 244B (e.g., associated with second population 146) and using corresponding ones of assigned ground-truth labels 220 and inferred ground-truth labels 254. For example, executed training input module 208 may receive candidate composition data 308, and may perform any of them exemplary processes described herein to generate a plurality of validation datasets 312 based on the data records allocated to validation fold 210B and to validation fold 244B, and additionally, or alternatively, based on elements of ingested customer profile, account, transaction, or credit-bureau data maintained within the one or more tangible, non-transitory memories of FI computing system 130 (e.g., within aggregated data store 132). In some instances, a composition, and a sequential ordering, of features values within each of validation datasets 312 may be consistent with the composition and corresponding sequential ordering set forth in candidate composition data 308.

Validation datasets 312 may, for example, include a validation dataset associated with each, or a subset, of the approved and funded applications for the unsecured lending products characterized by the data records of validation fold 210B, and with a corresponding one of assigned ground-truth labels 220. Further, by way of example, validation datasets 312 may also include a validation dataset associated with each, or a subset, of the rejected, or approved but unfunded, applications for the unsecured lending products characterized by the data records of validation fold 244B, and with a corresponding one of inferred ground-truth labels 254. Examples of these feature values include, but are not limited to, one or more of the feature values extracted, obtained, computed, determined, or derived by executed training input module 208 and packaged into corresponding potions of initial training datasets 224.

Referring back to FIG. 3A, executed training input module 208 may provide the plurality of validation datasets 312 and corresponding ones of assigned ground-truth labels 220 and inferred ground-truth labels 254 as inputs to executed adaptive training module 230. In some instances, executed adaptive training module 230 may obtain candidate process data 310 from pre-processed data store 143, and may perform operations that establish the plurality of nodes and the plurality of decision trees for the gradient-boosted, decision-tree process in accordance with each, or a subset, of candidate process data 310. Executed adaptive training module 230 may perform any of the exemplary processes described herein to apply the adaptively trained, gradient-boosted, decision-tree process to the elements of in-time, but out-of-sample, data maintained within respective ones of validation datasets 312, e.g., based on an ingestion and processing of the data maintained within respective ones of validation datasets 312 by the established nodes and decision trees of the adaptively trained, gradient-boosted, decision-tree process.

Further, executed adaptive training module 230 may also perform one or more of the exemplary processes described herein to generate elements of output data through the application of the adaptively trained, gradient-boosted, decision-tree process to a corresponding one of validation datasets 312, and to compute a value of one or more metrics, such as those described herein, that characterize a predictive capability, and an accuracy, of the adaptively trained, gradient-boosted, decision-tree process based on the generated elements of output data, corresponding ones of validation datasets 312, and corresponding ones of assigned ground-truth labels 220 and inferred ground-truth labels 254. In some examples, executed adaptive training module 230 may also perform operations that determine whether all, or a selected portion of, the computed metric values satisfy one or more threshold validation conditions, such as, but not limited to, the exemplary threshold validation conditions and predetermined threshold values described herein.

If, for example, executed adaptive training module 230 were to establish that one, or more, of the computed metric values fail to satisfy at least one of the threshold validation conditions, FI computing system 130 may establish that the adaptively trained, gradient-boosted, decision-tree process is insufficiently accurate for deployment may perform operations that transmit data indicative of the established inaccuracy to executed training input module 208, as described herein. Alternatively, if executed adaptive training module 230 were to establish that each computed metric value satisfies threshold validation conditions, FI computing system 130 may validate the adaptive training of the gradient-boosted, decision-tree process, and executed adaptive training module 230 may generate elements of validated composition data 314, which characterizes a composition of an input dataset for the adaptively trained, and now validated, machine-learning or artificial-intelligence process (e.g., the gradient-boosted, decision-tree process) and identifies each of the discrete feature within the input dataset, along with a sequence or position of these feature within the input dataset. Executed adaptive training module 230 may generate validated process data 316 that includes the one or more process parameters for the adaptively trained, machine-learning or artificial-intelligence process, such as, but not limited to, those exemplary process parameters described herein for the gradient-boosted, decision-tree. By way of example, executed adaptive training module 230 may perform one or more processes that adaptively or dynamically tune one or more hyperparameters of the trained gradient-boosted, decision-tree process using a grid search process, a random search process, or a Bayesian optimization process, such as an Optuna™ optimization process). Further, as illustrated in FIG. 3A, executed adaptive training module 230 may perform operations that store validated input data 314 and validated process data 316 within a locally accessible data repository, such as pre-processed data store 143.

In some instances, if executed adaptive training module 230 were to establish that each computed metric value satisfies threshold validation conditions, FI computing system 130 may deem the adaptively trained, and now-validated, machine-learning or artificial-intelligence process ready for deployment and real-time application to the elements of customer profile, account, transaction, credit-bureau, or application data described herein. In other examples, executed adaptive training module 230 may perform operations that further characterize an accuracy, and a performance, of the adaptively trained, and now-validated, machine-learning or artificial-intelligence process (e.g., the gradient-boosted, decision-tree process described herein) against elements of testing data associated with out-of-time testing interval Δt_{testing} (e.g., along timeline 204 of FIG. 2B) and maintained with the data records of both testing subset 212 of first population 144 (e.g., characterizing the approved and funded applications for the unsecured lending products) and testing subset 246 of second population 146 (e.g., characterizing the rejected, or approved but unfunded, applications for the unsecured lending products). In some instances, the further testing of the adaptively trained, and now-validated, gradient-boosted, decision-tree process against the elements of temporally distinct testing data may confirm a predictive capability of the adaptively trained and validated, machine-learning or artificial-intelligence process using previously unseen data, and may further establish the readiness of the adaptively trained and validated, machine-learning or artificial-intelligence process for deployment and real-time application to the elements of customer profile, account, transaction, credit-bureau, or application data described herein.

Referring to FIG. 3B, executed training input module 208 may obtain validated composition data 314 from pre-processed data store 141, and may perform any of them exemplary processes described herein to generate a plurality of testing datasets 318 based on data records of both testing subset 212 of first population 144 and testing subset 246 of second population 146 and additionally, or alternatively, based on previously ingested elements 320 of customer profile, account, transaction, or credit-bureau data that characterize one or more applicants involved in the applications for the unsecured lending products associated with corresponding ones of the data records (e.g., as maintained within aggregated data store 132). Testing datasets 318 may, for example, include a testing dataset associated with each, or a subset, of the approved and funded applications for the unsecured lending products characterized by the data records of testing subset 212, and with a corresponding one of assigned ground-truth labels 222. Further, by way of example, testing subset 212 may also include a testing dataset associated with each, or a subset, of the rejected, or approved but unfunded, applications for the unsecured lending products characterized by the data records of testing subset 246, and with a corresponding one of inferred ground-truth labels 256. As described herein, a composition, and a sequential ordering, of feature values within each of testing datasets 318 may be consistent with the composition and corresponding sequential ordering set forth in validated composition data 314, and feature values may include, but are not limited to, one or more of these exemplary feature values extracted, obtained, computed, determined, or derived by executed training input module 208, as described herein.

Executed training input module 208 may provide the plurality of testing datasets 318 and corresponding ones of assigned ground-truth labels 222 and inferred ground-truth labels 256 as inputs to executed adaptive training module 230, which may perform one or more of the exemplary processes described herein to apply the adaptively trained machine-learning or artificial-intelligence process (e.g., the trained gradient-boosted, decision-tree process, as described herein) to the elements of testing data maintained within respective ones of testing datasets 318 in accordance with the process parameters within validated process data 316. Further, executed adaptive training module 230 may also perform one or more of the exemplary processes described herein to generate elements of output data through the application of the adaptively trained, machine-learning or artificial-intelligence process to corresponding ones of testing datasets 318, and to compute a value of one or more metrics that characterize a predictive capability, and an accuracy, of the adaptively trained, and validated, machine-learning or artificial-intelligence process (e.g., (e.g., one or more exemplary metrics described herein for the adaptively trained, gradient-boosted, decision-tree process) based on the elements of output data, testing datasets 318, and corresponding ones of assigned ground-truth labels 222 and inferred ground-truth labels 256.

In some examples, executed adaptive training module 230 may determine whether all, or a selected portion of, the computed metric values satisfy one or more threshold conditions for a deployment of the adaptively trained, and validated, machine-learning or artificial-intelligence process and a real-time application to elements of application, customer profile, account, transaction, and credit-bureau data, such as, but not limited to, one or more of the exemplary predetermined threshold values described herein. If, for example, executed adaptive training module 230 were to establish that one, or more, of the computed metric values fail to satisfy at least one of the threshold deployment conditions, FI computing system 130 may establish that the adaptively trained, machine-learning or artificial-intelligence process is insufficiently accurate for deployment, and may perform operations that transmit data indicative of the established inaccuracy to executed training input module 208, as described herein. Alternatively, if executed adaptive training module 230 were to establish that each computed metric value satisfies threshold deployment conditions, FI computing system 130 may deem the adaptively training, and validated, machine-learning or artificial-intelligence process ready for deployment and real-time application to the elements of customer profile, account, transaction, credit-bureau, or application data described herein.

Executed adaptive training module 230 may generate final composition data 322, which characterizes a composition of an input dataset for the adaptively trained, machine-learning or artificial-intelligence process and identifies each of the feature values within the input dataset, along with a sequence or position of these feature values within the input dataset. Executed adaptive training module 230 may also generate final process data 324 that includes the one or more process parameters of the adaptively trained, and validated, machine-learning or artificial-intelligence process, such as, but not limited to, each of the exemplary process parameters described herein for the trained, gradient-boosted, decision-tree process. As illustrated in FIG. 3B, executed adaptive training module 230 may perform operations that store final composition data 322 and final process data 324 within the one or more tangible, non-transitory memories of FI computing system 130, such as pre-processed data store 141.

### B. Exemplary Processes for Predicting Occurrences in Real-Time Using Trained Artificial-Intelligence Processes and Inferred Ground-Truth Labelling

In some examples, one or more computing systems associated with or operated by a financial institution, such as one or more of the distributed components of FI computing system 130, may perform operations that adaptively train a machine-learning or artificial-intelligence process to predict likelihood of an occurrence, or a non-occurrence, of one or more targeted events involving an unsecured lending product during the future temporal interval using training and validation datasets associated with a first prior temporal interval and using testing datasets associated with a second, and distinct, prior temporal interval. As described herein, the future temporal interval may include an eighteen-month period disposed subsequent to a decision date of the corresponding application for the unsecured lending product, and the targeted events may include, but are not limited to, a delinquency event involving the unsecured lending product and characterized by a duration of greater than a threshold duration (e.g., ninety days) or an occurrence of a write-off of at least a threshold balance (e.g., $150.00) involving the unsecured lending product.

Additionally, and as described herein, the machine-learning or artificial-intelligence process may include an ensemble or decision-tree process, such as a gradient-boosted decision-tree process (e.g., the XGBoost process), and the unsecured lending product may include, but is not limited to, a credit-card account available for issuance to a corresponding applicant, or to corresponding applicants, by the financial institution. In some instances, the training, validation, and testing datasets may be associated with data records of first population 144 (e.g., that characterize approved and funded applications for the unsecured lending products involving a corresponding applicant or corresponding applicants) and corresponding assigned ground-truth labels, associated with data records of second population 146 (e.g., that characterize approved and funded applications for the unsecured lending products involving a corresponding applicant or corresponding applicants) and corresponding inferred ground-truth labels, and additionally or alternatively, associated with combinations of the data records of first population 144 and second population 146 and corresponding actual and inferred ground-truth labels, as maintained within pre-processed data store 141.

Further, in some examples, and based on an application of the trained machine-learning or artificial-intelligence process to an input dataset associated with a corresponding application for an unsecured lending product, FI computing system 130 perform any of the exemplary processes described herein to generate output data indicative of a predicted likelihood of an occurrence, or a non-occurrence, of one or more targeted events involving the unsecured lending product during the future temporal interval. The elements of output data may, for example, associate the corresponding application with an expected positive outcome (e.g., a predicted non-occurrence of any of the targeted events during the future interval) or alternatively, with an expected negative outcome (e.g., a predicted occurrence of at least one of the targeted events during the future interval). Further, as described herein, output data indicative of the predicted likelihood of the occurrence or non-occurrence the one or more targeted events involving the unsecured lending product during the future temporal interval and as such, the expected positive or negative outcome of the corresponding application, may inform a decision by the financial institution to approve or reject the corresponding application for the unsecured lending product, which may be provisioned to a device operable by an applicant or a representative of the financial institution in real-time and contemporaneously with an initiation of the application (e.g., within a threshold time period, such as, but not limited to, ten second, twenty seconds, or thirty seconds).

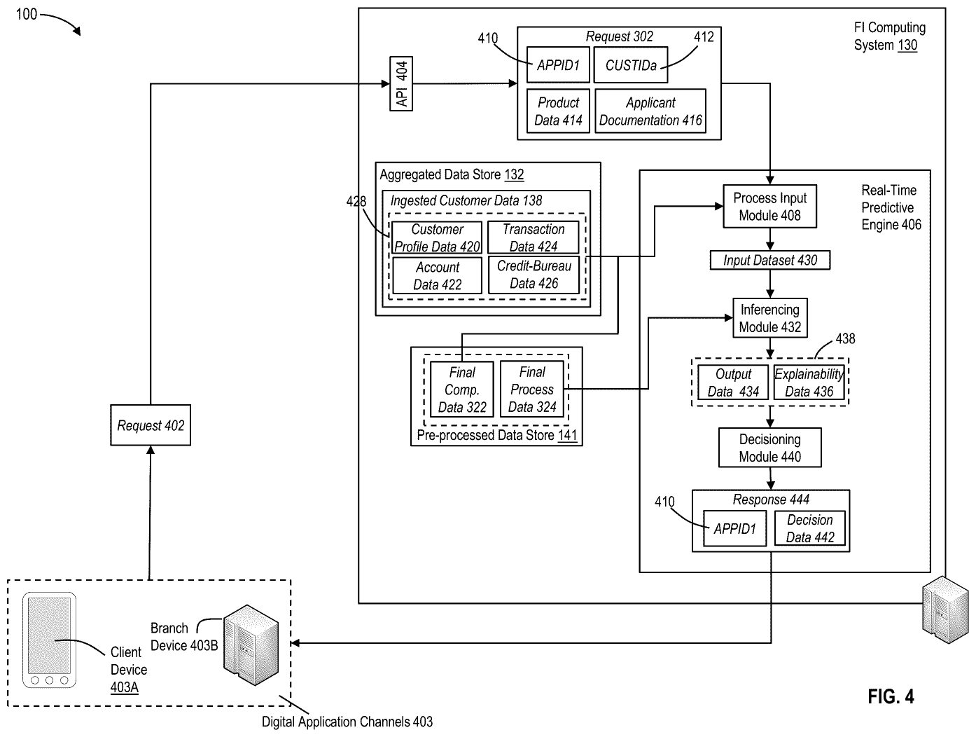

Referring to FIG. 4, a customer of a financial institution (e.g., an applicant) may elect to apply for an unsecured lending product, such as a credit-card account available for issuance by the financial institution, and may initiate the application process by providing input to an application program executed by a corresponding client device 403A, e.g., via a corresponding digital interface. In other examples, the customer may visit a physical branch of the financial institution, and may provide information to a representative of the financial institution, who may input the information into an application program executed at a branch device 403B, e.g., via an additional digital interface. Client device 403A and/or branch device 403B (e.g., collectively referred to as a digital application channels 403), may generate elements of a request 402 for an application for the credit-card account, and transmit the elements of request 402 across communications network 120 to FI computing system 130.

In some instances, client device 403A and branch device 403B may include a computing device having one or more tangible, non-transitory memories that store data and/or software instructions, and one or more configured to execute the software instructions. The one or more tangible, non-transitory memories may, in some aspects, store software applications, application modules, and other elements of code executable by the one or more processors, such as, but not limited to, an executable web browser (e.g., Google Chrome™, Apple Safari™, etc.) and an executable application associated with FI computing system 130 (e.g., a mobile banking application). Each of client device 403A and branch device 403B may also include a display unit configured to present interface elements to a corresponding user, and an input unit configured to receive input from the corresponding user, e.g., in response to the interface elements presented through the display unit. By way of example, the display unit may include, but is not limited to, an LCD display unit or other appropriate type of display unit, and the input unit may include, but is not limited to, a keypad, keyboard, touchscreen, voice activated control technologies, or appropriate type of input unit. In some instances, the functionalities of the display and input units may be combined into a single device, e.g., a pressure-sensitive touchscreen display unit that presents interface elements and receives input from the corresponding user. Each of client device 403A and branch device 403B may also include a communications interface, such as a wireless transceiver device, coupled to a corresponding processor and configured by that corresponding processor to establish and maintain communications with communications network 120 via one or more communication protocols, such as WiFi®, Bluetooth®, NFC, a cellular communications protocol (e.g., LTE®, CDMA®, GSM®, etc.), or any other suitable communications protocol.

Examples of client device 403A and branch device 403B may include, but not limited to, a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays (OHMDs)), an embedded computing device (e.g., in communication with a smart textile or electronic fabric), and any other type of computing device that may be configured to store data and software instructions, execute software instructions to perform operations, and/or display information on an interface device or unit, such as the display unit. In some instances, client device 403A and branch device 403B may also establish communications with one or more additional computing systems or devices operating within environment 100 across a wired or wireless communications channel, e.g., via the corresponding communications interface using any appropriate communications protocol.

Referring back to FIG. 4, a programmatic interface associated with a real-time predictive engine executed by FI computing system 130, such as application programming interface 404 of real-time predictive engine 406, may receive request 402, and route request 402 to a process input module 408 of executed real-time predictive engine 406. For example, as described herein, the customer may elect to apply for an rewards-based, credit-card account, and request 402 may include an application identifier 410 (e.g., an alphanumeric identifier, such as “APPID1,” assigned by the application program executed by client device 403A or alternatively, by the branch device 403B) and an applicant identifier 412 (e.g., an, alphanumeric identifier associated with the customer, such as “CUSTIDa,” which may be assigned by FI computing system 130 or by the application program executed by client device 403A or branch device 403B).

As illustrated in FIG. 4, request 402 may also include elements of product data 414, which identify and characterize the rewards-based, credit-card account associated with the application, and elements of applicant documentation 416, which identifies and characterizes the applicant, and supports the application for the rewards-based credit-card account. In some instances, the application program executed by client device 403A, or alternatively, by branch device 403B, may generate the elements of product data 414 and the elements of applicant documentation 416 based on input provided by the customer to a corresponding one of client device 403A or branch device 403B (e.g., via a corresponding display unit) and/or based on additional data characterizing the customer and interactions between the customer and the financial institution (or other financial institution), which may be available to the application program executed by the corresponding one of client device 403A or branch device 403B.

By way of example, the elements of product data 414 may include, but are not limited to, a unique identifier of the rewards-based, credit-card account (e.g., a product name, an alphanumeric identifier assigned to the rewards-based, credit-card account by FI computing system 130, etc.) and a value of one or more parameters of the rewards-based, credit-card account, such as an initial credit limit and a fixed or variable interest rate. Further, the elements of applicant documentation 416 may include, but are not limited to, a full name of the applicant, a unique governmental identifier assigned to the applicant by a governmental entity (e.g., a social-security number or a driver's license number of the customer, etc.), one or more demographic parameters characterizing the applicant (e.g., a customer birth date, etc.), and information characterizing employment or income of the applicant.

In some instances, executed real-time predictive engine 406 may perform operations that, based on an application of an adaptively trained, machine-learning or artificial-intelligence process (e.g., and adaptively trained gradient-boosted, decision-tree process, such as the trained XGBoost process described herein) to the input dataset, generate an element output data indicative of a predicted likelihood of an occurrence, or a non-occurrence, of one or more targeted events involving the rewards-based, credit-card account during the future temporal interval. As described herein, the future temporal interval may include an eighteen-month period, and the targeted events may include, but are not limited to, a delinquency event involving the rewards-based, credit-card account and characterized by a duration of greater than a threshold duration (e.g., ninety days) or an occurrence of a write-off of at least a threshold balance (e.g., $150.00) involving the rewards-based credit-card account.

The elements of outcome data may, for example, associate the corresponding application for the rewards-based, credit-card account with an expected positive outcome (e.g., a predicted non-occurrence of any of the targeted events during the future interval) or alternatively, with an expected negative outcome (e.g., a predicted occurrence of at least one of the targeted events during the future interval), and the elements of output data, and the expected positive or negative outcome of the corresponding application, may inform a decision by the financial institution to approve or reject the corresponding application for the rewards-based. In some instances, executed real-time predictive engine 406 may perform operations that generate and provision a response to request 402 that includes the elements data characterizing the decision to a corresponding one of client device 403A or branch device 403B that generated request 402 (e.g., for presentation within a corresponding display unit) in real-time and contemporaneously with the generation of request 402 or of a receipt of receipt of request 402 by FI computing system 130 (e.g., within a threshold time period, such as, but not limited to, ten second, twenty seconds, thirty seconds, or one minute).

Referring back to FIG. 4, executed process input module 408 may perform operations that obtain, from pre-processed data store 141, elements of final composition data 322 that characterize a composition of an input dataset for the adaptively trained, and validated, machine-learning or artificial-intelligence process (e.g., the adaptively trained, and validated gradient-boosted, decision-tree process described herein) and identify each of the discrete feature values within the input dataset, along with a sequence or position of these feature values within the input dataset. By way of example, executed process input module 408 may perform operations, described herein, that obtain or extract one or more of the input features values specified within the elements of final composition data 322 from corresponding portions of request 402, e.g., from portions of product data 414 or applicant documentation 416 and additionally, or alternatively, from elements of previously ingested customer profile, account, transaction, or credit-bureau data that characterize the applicant involved in the application for the rewards-based credit-card account, e.g., the customer.

For example, executed process input module 408 may parse request 402 and obtain each of applicant identifier 412 of the customer (e.g., “CUSTIDa”), and as illustrated in FIG. 4, executed process input module 408 may access ingested customer data 138 maintained within aggregated data store 132, and based on applicant identifier 412, access and obtain elements of customer profile data 420, account data 422, transaction data 424, and credit bureau data 426 that characterize the applicant involved in the application for the rewards-based, credit-card account and the interactions of the applicant with the financial institution, and with other financial institutions and related entities. The obtained elements of customer profile data 420, account data 422, transaction data 424, and credit bureau data 426 may, for example, include respective ones of the exemplary elements of customer profile data 110, account data 112, transaction data 114, and credit-bureau data 116 ingested by executed data ingestion engine 136 (as described herein), and the obtained elements of customer profile data 420, account data 422, transaction data 424, and credit bureau data 426 may be characterized collectively as elements of interaction data 428. In some instances, executed process input module 408 may perform operations that obtain or extract additional, or alternative, ones of the input features values specified within the elements of final composition data 322 from corresponding ones of the elements of customer profile data 420, account data 422, transaction data 424, and credit bureau data 426, e.g., in accordance with the elements of final composition data 322.

Further, in some examples, executed process input module 408 may perform operations that compute, determine, or derive one or more of the features values based on elements of data extracted or obtained from the corresponding portions of request 402 (e.g., from portions of product data 414 or applicant documentation 416), and additionally, or alternatively, from the obtained elements of customer profile data 420, account data 422, transaction data 424, and credit bureau data 426 (e.g., the elements of interaction data 428). Examples of these obtained or extracted input feature values, and of these computed, determined, or derived input feature values, include, but are not limited to, one or more of the feature values extracted, obtained, computed, determined, or derived by executed training input module 208 and packaged into corresponding potions of initial training datasets, validation datasets, and testing datasets, as described herein.

Executed process input module 408 may perform operations that package each of the obtained, extracted, computed, determined, or derived feature values into corresponding portions of input dataset 430 in accordance with the respective positions specified within the elements of final composition data 322. As illustrated in FIG. 4, an inferencing module 432 of executed real-time predictive engine 406 may perform operations that obtain, from pre-processed data store 141, elements of final process data 324 that includes one or more process parameters of the adaptively trained, machine-learning or artificial-intelligence process, such as those exemplary processes parameters described herein the adaptively trained, gradient-boosted, decision-tree process. Executed inferencing module 432 may perform operations that apply the adaptively trained, machine-learning or artificial-intelligence process to the feature values within input dataset 430 in accordance with the process parameters within final process data 324. Further, and based on the application of the adaptively trained, machine-learning or artificial-intelligence process to the feature values, executed inferencing module 432 may generate elements of output data 434 indicative of the predicted likelihood of an occurrence, or a non-occurrence, of the one or more targeted events involving the rewards-based, credit-card account during the eighteen-month, future temporal interval and elements of explainability data 434 that characterize a relative importance of one or more of the feature values of input dataset 430 on the predicted output of the trained machine-learning or artificial-intelligence process

For example, and based on the process parameters of final process data 324, executed inferencing module 432 may perform operations that establish a plurality of nodes and a plurality of decision trees for the adaptively trained, gradient-boosted, decision-tree process, each of which receive, as inputs, corresponding feature values of input dataset 430 (e.g., to “ingest” the corresponding feature values of input dataset 430). Further, and based on the execution of inferencing module 432, and on the ingestion of input dataset 430 by the established nodes and decision trees of the adaptively trained, gradient-boosted, decision-tree process, FI computing system 130 may perform operations that apply the adaptively trained, gradient-boosted, decision-tree process to input dataset 430, and that generate the elements of output data 434 and the elements of explainability data 436.

As described herein, the targeted events may include, but are not limited to, a delinquency event involving the rewards-based, credit-card account and characterized by a duration of greater than a threshold duration (e.g., ninety days) or an occurrence of a write-off of at least a threshold balance (e.g., $150.00) involving the rewards-based credit-card account. Further, and in view of the predicted occurrence or non-occurrence of these targeted events, the elements of output data 434 may also associate the application for the rewards-based, credit-card account characterized by request 402 with an expected positive outcome during the eighteen-month, future temporal interval (e.g., a predicted non-occurrence of any of the targeted events) or alternatively, with an expected negative outcome during the eighteen-month, future temporal interval (e.g., a predicted occurrence of at least one of the targeted events). By way of example, the elements of output data 434 may include a binary, numerical output indicative of the predicted likelihood of an occurrence, or a non-occurrence, of one or more targeted events involving the rewards-based, credit-card account during the eighteen-month, future temporal interval and as such, indicative of expected outcome positive or negative outcome associated with application for the rewards-based, credit-card account characterized by request 402 during the eighteen-month, future temporal interval (e.g., a value of zero for an expected positive outcome, and a value of unity for an expected negative outcome).

Further, in some instances, the elements of explainability data 436 may include, among other things, one or more Shapley values that characterize an average marginal contribution of corresponding ones of the feature values to predicted output data 434. Additionally, or alternatively, the elements of explainability data 436 may also include values of probabilistic metrics that average a computed area under curve for receiver operating characteristic (ROC) curves for the binary classification, or other metrics that would characterize the relative importance of one or more of the input feature values included within input dataset 430 and that would be appropriate to the feature values within input dataset 430 or to the adaptively trained, gradient-boosted decision-tree process. As illustrated in FIG. 3, executed inferencing module 432 may package into the elements of output data 434 and the elements of explainability data into corresponding portions of predictive output 438, which executed inferencing module 432 may provision as an input to a decisioning module 440 of executed real-time predictive engine 406, either individually or in conjunction with input dataset 430.

In some instances, and upon receipt of predictive output 438 (e.g., and additionally, or alternatively, of input dataset 430), executed decisioning module 440 may perform operations that obtain application identifier 410 from request 402 (e.g., “APPID1”). Further, and based on the elements of output data 436, which include the binary numerical output indicating, among other things, expected outcome positive or negative outcome associated with application for the rewards-based, credit-card account characterized by request 402 during the eighteen-month, future temporal interval (e.g., a value of zero for an expected positive outcome, and a value of unity for an expected negative outcome), executed decisioning module 440 may determine to approve, or alternatively, reject the application for the rewards-based, credit-card account characterized by request 402, and generate elements of decision data 442 indicative of the determined approval or rejection of the application.

For example, if the elements of output data 434 were to associate the application for the rewards-based, credit-card account characterized by request 402 with an expected positive outcome during the eighteen-month, future temporal interval, executed decisioning module 440 may approve the application and may generate one or more elements of decision data 442 indicative of the determined approval of the application (e.g., a binary value of zero or alphanumeric character string, such as “APPROVED”). Alternatively, if the elements of output data 434 were to associate the application for the rewards-based, credit-card account characterized by request 402 with an expected negative outcome during the eighteen-month, future temporal interval, executed decisioning module 440 may reject the application and may generate one or more elements of decision data 442 indicative of the determined rejection of the application (e.g., a binary value of unity or alphanumeric character string, such as “REJECT”). Executed decisioning module 440 may package application identifier 410 and the elements of decision data 442, which indicates approval, or alternatively, the rejection of the application for the rewards-based, credit-card account characterized by request 402 into corresponding portions of a response 444 to request 402.

As illustrated in FIG. 4, executed real-time predictive engine 406 may cause FI computing system 130 to perform operations that transmit all, or a selected portion of, response 444 across communications network 120 to a corresponding one of digital application channels 403 that initiated the application for the rewards-based, credit-card account and that generated request 402, e.g., one of client device 403A and branch device 403B. In some examples, the application program executed by client device 403A, or by branch device 403B, may process application identifier 410 and the elements of decision data 442 and may perform operations that generate and present, within a corresponding digital interface via the display unit, elements of digital content that confirm, to the customer, the decision to approve or reject of the application for the rewards-based, credit-card account, within a corresponding digital interface. The customer may, for example, obtain the decision approving or rejecting the application for the rewards-based, credit-card account real-time and contemporaneously with the submission of the application (e.g., within a threshold time period, such as, but not limited to, ten second, twenty seconds, or thirty seconds, of the generation of request 402 by client device 403A or branch device 403B).

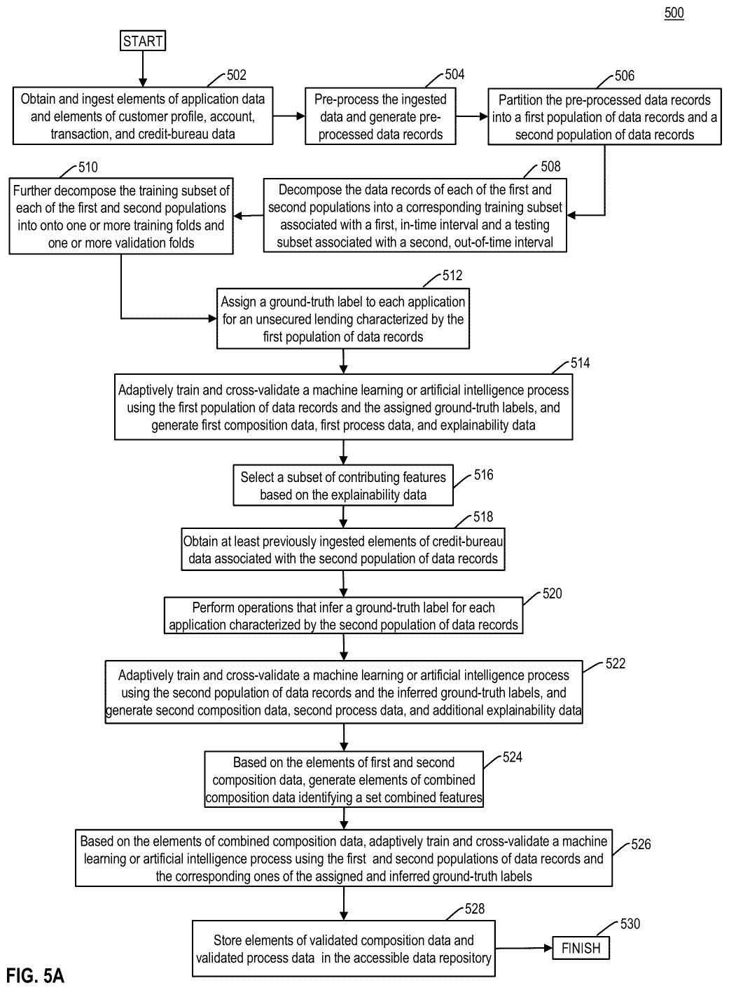

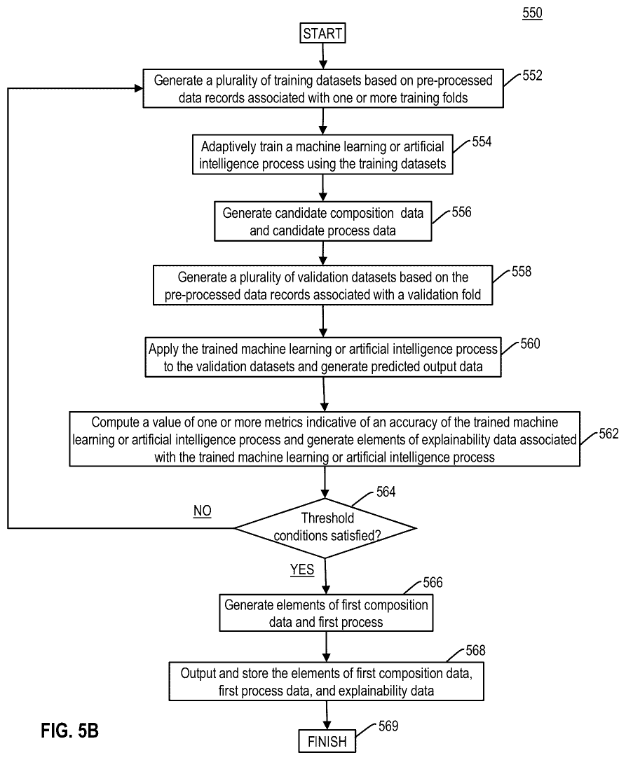

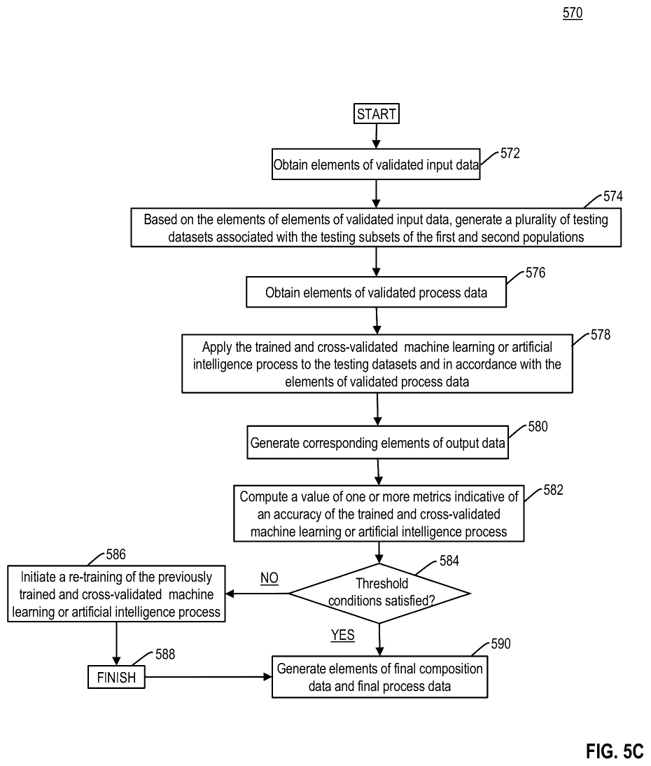

FIGS. 5A, 5B, and 5C are flowcharts of an exemplary process for adaptively training, cross-validating, and testing a machine-learning or artificial-intelligence process using datasets having inferred ground-truth labels, in accordance with some examples. As described herein, the machine-learning or artificial-intelligence process may include an ensemble or decision-tree process, such as a gradient-boosted decision-tree process (e.g., the XGBoost process), and one or more of the exemplary processes described herein may utilize partitioned training and validations datasets associated with a first prior temporal interval (e.g., an in-time training interval), and testing datasets associated with a second, and distinct, prior temporal interval (e.g., an out-of-time testing interval). Further, one or more computing systems, such as, but not limited to, one or more of the distributed components of FI computing system 130, may perform one or more of the steps of exemplary process 500, described in reference to FIG. 5A, exemplary process 550, described in reference to FIG. 5B, and exemplary process 570, described in reference to FIG. 5C.

Referring to FIG. 5A, FI computing system 130 may establish a secure, programmatic channel of communication with one or more source computing systems, such as source systems 102 of FIG. 1, and may perform one or more of the exemplary processes described herein to obtain, from the source computing systems, elements of application data that identify or characterize one or more applications for unsecured lending products (e.g., the credit-card accounts described herein) initiated by, or involving, one or more corresponding applicants during one or more temporal intervals (e.g., in step 502 of FIG. 5A). FI computing system 130 may also perform one or more of the exemplary processes described herein to obtain, from the source computing systems, elements of customer profile, account, and transaction data that that identify and characterize one or more customers of the financial institution during the one or more temporal intervals, and elements of credit-bureau data that characterize one or more customers of the financial institution (and in some instances, prospective customers of the financial institution) during the one or more temporal intervals (e.g., also in step 502 of FIG. 5A).

FI computing system 130 may also perform operations, such as those described herein, that store (or ingest) the obtained elements of application, customer profile, account, transaction and credit-bureau data within one or more accessible data repositories, such as aggregated data store 132, in conjunction with temporal data characterizing corresponding ingestion dates (e.g., also in step 502 of FIG. 5). In some instances, FI computing system 130 may perform operations, such as those describe herein, to obtain and ingest the elements of application, customer profile, account, transaction and credit-bureau data in accordance with a predetermined temporal schedule (e.g., on a monthly basis at a predetermined date or time, etc.), or a continuous streaming basis, across the secure, programmatic channel of communication.

In some instances, FI computing system 130 may access the ingested elements of application data, including corresponding application identifiers, elements of decision data and temporal data, elements of product data and the elements of applicant documentation, and may perform one or more of the exemplary processes described herein to aggregate, filter, and process selectively the accessed elements of application data and generate one or more data records that characterize corresponding ones of the applications for the unsecured lending products (e.g., in step 504 in FIG. 5A). As described herein, FI computing system 130 may store each of the data records within one or more accessible data repositories, such as pre-processed data store 141 (e.g., also in step 504 of FIG. 5A).

Further, and as described herein, each of the data records may be associated with a corresponding application for an unsecured lending product available for provisioning by the financial institution (e.g., the credit-card accounts described herein), and each of the applications may be associated with a corresponding approval decision (e.g., approve or reject, etc.) and in some instances, a corresponding status (e.g., approved and funded, or approved but unfunded, etc.). In some instances, FI computing system 130 may also perform any of the exemplary processes described herein to partition the data records into a first population of the data records characterizing applications that are both approved by the financial institution and funded by the financial institution for use in transactions subsequent to approval, and into a second population of the data records characterizing applications that are either rejected by the financial institution, or alternatively, that are approved by the financial institution but remain unfunded (e.g., in step 506 of FIG. 5A).

Based on the decision dates specified by the data records, FI computing system 130 may perform any of the exemplary processes described herein to decompose each of the first and second populations of the data records into (i) a corresponding first of the data records that are associated with applications having decisions dates disposed within a first prior temporal interval (e.g., the in-time training interval Δt_{training}, as described herein) and (ii) a corresponding second subset (e.g., a testing subset) of the data records that are associated with applications having decisions dates disposed within a second prior temporal interval (e.g., the out-of-time testing interval Δt_{testing}, as described herein), which may be separate, distinct, and disjoint from the first prior temporal interval (e.g., in step 508 of FIG. 5A). Further, FI computing system 130 may also perform any of the exemplary processes described herein to further decompose the first subset of each of the first and second populations of the data records into one or more partitions or folds that facilitate the adaptive training a machine-learning or artificial-intelligence process during the in-time training interval Δt_{training}, such as, but not limited to training fold 210A of FIG. 2A or training fold 244A of FIG. 2C, and one or more partitions or folds that facilitate a cross-validation of the adaptively trained machine-learning or artificial-intelligence process during the in-time training and interval Δt_{training}, such as validation fold 210B of FIG. 2A or validation fold 244B of FIG. 2C (e.g., in step 510 of FIG. 5A).

In some instances, as the first population of data records, including the decomposed first subset and the second, one or more of the previously ingested elements of account or transaction data may characterize a corresponding applicant's use, or misuse, of each of these unsecured lending products (e.g., the credit-card accounts, etc.) subsequent to the approval and funding of the corresponding application. Referring back to FIG. 5A, FI computing system 130 may perform any of the exemplary processes described herein to assign, to each of the approved and funded applications characterized by the first population of data records, including the data records within the first subset and the second subset, a ground truth label based on previously ingested elements of account and transaction data associated with the corresponding approved and funded application or with a corresponding applicant or applicants (e.g., in step 512 of FIG. 5A).

Further, FI computing system 130 may perform one or more of the exemplary processes described herein to adaptively train, and cross-validate, machine-learning or artificial-intelligence process to predict a likelihood of an occurrence, or a non-occurrence, of one or more targeted events involving an unsecured lending product associated with a corresponding application during a future temporal interval and using training and validation datasets associated with, respectively, data records allocated to a training fold of the first population (e.g., training fold 210A of FIG. 2A) and data records allocated to a validation fold of the first population (e.g., validation fold 210B of FIG. 2A), and using corresponding ones of the assigned, ground-truth labels (e.g., in step 514 of FIG. 5A). As described herein, the machine-learning or artificial-intelligence process may include, but is not limited to, an ensemble or decision-tree process, such as a gradient-boosted decision-tree process (e.g., the XGBoost process). Further, and as described herein, the future temporal interval may include an eighteen-month period disposed subsequent to a decision date of the corresponding application for the unsecured lending product, and the targeted events may include, but are not limited to, a delinquency event involving the unsecured lending product and characterized by a duration of greater than a threshold duration (e.g., ninety days) or an occurrence of a write-off of at least a threshold balance (e.g., $150.00) involving the unsecured lending product. FIG. 5B illustrates additional steps of the exemplary processes for adaptively training, and cross-validating, the machine-learning or artificial-intelligence processes described herein.

Referring to FIG. 5B, FI computing system 130 may perform any of the exemplary processes described herein to generate one or more initial training datasets based on the data records allocated to one, or more, corresponding training folds (such as, but not limited to, training fold 210A of training subset 210 of FIG. 2A or training fold 244A of training subset 244 of FIG. 2C), and additionally, or alternatively, based on previously ingested elements of customer profile, account, transaction, or credit-bureau data maintained within the one or more tangible, non-transitory memories of FI computing system 130 (e.g., in step 552 of FIG. 5B). As described herein, each of initial training datasets 224 may be associated with a corresponding application for an unsecured lending products (e.g., a credit-card account, as described herein) characterized by decision date disposed within disposed within the training interval Δt_{training}.

In some examples, each of the initial training datasets may include, among other things, an application identifier associated with the corresponding application, an applicant identifier of a corresponding applicant (or applicants), temporal data characterizing the corresponding decision date. Further, each of initial training datasets may also include elements of data (e.g., feature values) that characterize the corresponding application for the unsecured lending product and additionally, or alternatively, the applicant (or applicants) involved in the corresponding application. Each of the initial training datasets may also be associated with a corresponding, application-specific ground-truth labels, which associates the initial training dataset with a positive target (e.g., indicative of a determined non-occurrence of any of the targeted events during the future temporal interval) or a negative target (e.g., indicative of a determined occurrence of at least one of the targeted events during the future temporal interval). Examples of the application-specific ground-truth labels include, but are not limited to, one or more of the assigned ground-truth labels (e.g., ground-truth labels 218 or 220 of FIG. 2A) or one or more of the inferred ground-truth labels (e.g., inferred ground-truth labels 252 or 254 of FIG. 2C).

Based on the plurality of initial training datasets, FI computing system 130 may also perform any of the exemplary processes described herein to train adaptively the machine-learning or artificial-intelligence process (e.g., the gradient-boosted, decision-tree process described herein) against the elements of training data included within each of the initial training datasets and corresponding ones of ground-truth labels (e.g., in step 554 of FIG. 5B). For example, and as described herein, FI computing system 130 may perform operations that establish a plurality of nodes and a plurality of decision trees for the gradient-boosted, decision-tree process (i.e., in accordance with an initial set of process parameters), which may ingest and process the elements of training data (e.g., the customer identifiers, the temporal identifiers, the feature values, etc.) maintained within each of the plurality of the initial training datasets.

Through the performance of these adaptive training processes, FI computing system 130 may perform may generate elements of candidate composition data identifying one or more candidate features of a corresponding input dataset for the trained machine-learning or artificial-intelligence process, along with a sequential position of each candidate feature within the corresponding input dataset (e.g., in step 556 of FIG. 5B). Further, and through the performance of these adaptive training processes, FI computing system 130 and may perform operations, described herein, to compute one or more candidate process parameters that characterize the adaptively trained machine-learning or artificial-intelligence process (e.g., the gradient-boosted, decision-tree process described herein), and package the candidate process parameters into corresponding portions of candidate process data (e.g., also in step 556 of FIG. 5B).

In some instances, based on the elements of candidate composition data and candidate process data, FI computing system 130 may also perform any of the exemplary processes described herein to cross-validate the trained machine-learning or artificial-intelligence process (e.g., the trained gradient-boosted, decision-tree process) against, among other things, elements validation data maintained within the data records allocated to a corresponding validation fold, such as, but not limited to, validation fold 210B of training subset 210 of FIG. 2A or validation fold 244B of training subset 244 of FIG. 2C. As described herein, each of the allocated data records may be associated with a corresponding application for an unsecured lending product (e.g., a credit-card account, as described herein) characterized by a decision date disposed within disposed within the first prior temporal interval, e.g., training interval Δt_{training}. For example, FI computing system 130 may perform any of the exemplary processes described herein generate a plurality of validation datasets based on data records allocated to the corresponding validation fold and additionally, or alternatively, based on previously ingested elements of customer profile, account, transaction, or credit-bureau data associated with corresponding ones of the applications (e.g., in step 558 of FIG. 5B). As described herein, a composition, and a sequential ordering, of features values within each of the validation datasets may be consistent with the composition and corresponding sequential ordering set forth in the elements of candidate composition data, and each of the validation datasets may be associated with a corresponding ground truth label (e.g., the assigned or inferred ground-truth labels).

FI computing system 130 may perform any of the exemplary processes described herein to apply the adaptively trained machine-learning or artificial-intelligence process (e.g., the adaptively trained, gradient-boosted, decision-tree process described herein) to respective ones of the validation datasets in accordance with the candidate process parameters, and to generate corresponding elements of output data (e.g., in step 560 of FIG. 5B). In some instances, each of elements of output data may indicate a predicted likelihood of an occurrence, or a non-occurrence, of one or more targeted events involving an unsecured lending product associated with a corresponding application (and a corresponding one of the validation datasets) during a future temporal interval. FI computing system 130 may also perform any of the exemplary processes described herein to compute a value of one or more metrics that characterize a predictive capability, and an accuracy, of the adaptively trained machine-learning or artificial-intelligence process (such as the adaptively trained, gradient-boosted, decision-tree process described herein) based on the generated elements of output data, corresponding ones of the validation datasets, and the respective ground-truth labels (e.g., in step 562 of FIG. 5). Further, FI computing system 130 may perform any of the exemplary processes described herein to generate elements of explainability data, such as, but not limited to, a raw, averaged, or aggregated Shapley value, that characterize a relative importance of each of the features values within the validation datasets to a predictive output of the adaptively trained, machine-learning or artificial-intelligence process (e.g., also in step 562 of FIG. 5B).

FI computing system 130 may also perform operations to determine whether all, or a selected portion of, the computed metric values satisfy one or more threshold validation conditions, such as, but not limited to, those described herein (e.g., in step 564 of FIG. 5). If, for example, FI computing system 130 were to establish that one, or more, of the computed metric values fail to satisfy at least one of the threshold validation conditions (e.g., in step 564; NO), FI computing system 130 may establish that the adaptively trained, machine-learning or artificial-intelligence process is insufficiently accurate for deployment. Exemplary process 550 may pass back to step 552, and FI computing system 130 may perform any of the exemplary processes described herein to generate additional training datasets based on the data records allocated to one, or more, of the corresponding training folds.

Alternatively, if FI computing system 130 were to establish that each computed metric value satisfies each of the validation conditions, FI computing system 130 may perform any of the exemplary processes described herein to generate elements of first composition data, which characterize a composition of an input dataset for the adaptively trained, machine-learning or artificial-intelligence process (e.g., the trained, gradient-boosted, decision-tree process) and identifies each of feature values within the input dataset, along with a sequence or position of the feature values within the input dataset (e.g., in step 566 of FIG. 5B). Further, FI computing system may also perform operations, described herein, to generate elements of first process data that include the one or more process parameters of the adaptively trained and cross-validated machine-learning or artificial-intelligence process, such as, but not limited to, one or more of the exemplary process parameters described herein for the trained, gradient-boosted, decision-tree process (e.g., also in step 566 of FIG. 5B). In some instances, FI computing system 130 may output the elements of first composition data, first process data, and explainability data, and additionally, or alternatively, may store the elements of first composition data, first process data, and explainability data within a locally or remotely accessible data repository (e.g., in step 568 of FIG. 5B). Exemplary process 550 is then complete in step 569.

Referring back to FIG. 5A, and through a performance of one or more of the exemplary adaptive training and cross-validation processes described herein, FI computing system 130 may generate the elements of first composition data that characterize the composition of a first input dataset for the adaptively trained machine-learning or artificial-intelligence process (e.g., identifying first features and corresponding positions within the first input dataset), elements of first process data that include the one or more process parameters of the adaptively trained machine-learning or artificial-intelligence process, and the elements of explainability data that characterize the adaptively trained machine-learning or artificial-intelligence process (e.g., also in step 514 of FIG. 5A). FI computing system 130 may perform operations that store the elements of first composition data, first process data, and explainability data within an accessible local or remote data repository, such as within pre-processed data store 141 of FIG. 2A (e.g., also in step 514 of FIG. 5A).

In some instances, FI computing system 130 may access the elements of explainability data associated with the trained machine-learning or artificial-intelligence process (e.g., using the training and validation datasets associated with the data records of the first population, which characterize the approved and funded applications), and select a subset of the features that contribute to the predictive output of the trained machine-learning or artificial-intelligence process (e.g., in step 516 of FIG. 5A). As described herein, the selected subset of contributing features may include, but not limited to, those features associated with corresponding Shapley values that exceed a predetermined threshold value, or a predetermined number of features characterized by Shapley values of the largest magnitude, and in some instances, the selected features may be associated with one or more events, such as, but are not limited to, an occurrence of a write-off or other negative treatment of a financial services account, or an occurrence of a delinquency event of at least a threshold duration, such as, but not limited to, thirty days, sixty days, ninety days, or 120 days.

FI computing system 130 may also perform operations, described herein, to obtain one or more previously ingested elements of credit-bureau data, and in some instances, previously ingested elements of customer-profile, account, or transaction data, associated with each of the applicants involved in the rejected, or approved but unfunded, applications characterized by the data records of the second population (e.g., in step 518 of FIG. 5A). In some instances, and based on the previously ingested elements of credit-bureau data (and in some instances, on the previously ingested elements of customer-profile, account, or transaction data), FI computing system 130 may perform any of the exemplary processes described herein to infer a ground-truth values for corresponding ones of the rejected, or approved but unfunded, applications based on a determined occurrence, or non-occurrence, of the one or more events associated with the selected subset of contributing features during a temporal interval disposed subsequent to a decision date of the corresponding application (e.g., in step 520 of FIG. 5A). As described herein, the temporal interval may include, but is not limited to, a twelve-month temporal interval disposed between six and eighteen months subsequent to the decision date of the corresponding application.

In some instances, FI computing system 130 may perform any of the exemplary processes described herein to further adaptively train the machine-learning or artificial-intelligence process using additional training and validation datasets associated with, respectively, data records allocated to a training fold of the second population (e.g., training fold 244A of FIG. 2C) and data records allocated to a validation fold of the second population(e.g., validation fold 244B of FIG. 2C), and using corresponding ones of the inferred, ground-truth labels (e.g., in step 522 of FIG. 5A). As described herein, the machine-learning or artificial-intelligence process may include, but is not limited to, an ensemble or decision-tree process, such as a gradient-boosted decision-tree process (e.g., the XGBoost process), and FIG. 5B illustrates additional steps of the exemplary processes for adaptively training, and cross-validating, the machine-learning or artificial-intelligence processes described herein.

Through a performance of one or more of the exemplary adaptive training and cross-validation processes described herein, FI computing system 130 may generate the elements of second composition data that characterizes a composition of a second input dataset for the adaptively trained machine-learning or artificial-intelligence process (e.g., second features and corresponding positions within the second input dataset), elements of second process data that include the one or more process parameters of the adaptively trained machine-learning or artificial-intelligence process, and elements of additional explainability data that characterize the further adaptively trained machine-learning or artificial-intelligence process (e.g., also in step 522 of FIG. 5A). FI computing system 130 may perform operations that store the elements of second composition data, second process data, and additional explainability data within an accessible local or remote data repository, such as within pre-processed data store 141 of FIG. 2A (e.g., also in step 522 of FIG. 5A).

In some examples, FI computing system 130 may obtain the elements of first composition data and second composition data, and based on the elements of first composition data and second composition data, FI computing system 130 may perform any of the exemplary processes described herein to generate elements of combined composition data identifying a set of combined features that include each, or a subset of, the features associated with respective ones of the first and second composition data (e.g., in step 524 of FIG. 5A). Further, and in accordance with the combined features of the elements of combined composition data, FI computing system 130 may also perform any of the exemplary processes described herein to adaptively train, and cross-validate, the machine-learning or artificial-intelligence process using further training and validation datasets associated, respectively, with data records allocated to training folds of the first and second populations (e.g., training fold 210A of FIG. 2A and training fold 244A of FIG. 2C) and data records allocated to validation folds of the first and second populations (e.g., validation fold 210B of FIG. 2A and validation fold 244B of FIG. 2C), and using corresponding ones of the assigned and inferred, ground-truth labels (e.g., in step 526 of FIG. 5A). As described herein, the machine-learning or artificial-intelligence process may include, but is not limited to, an ensemble or decision-tree process, such as a gradient-boosted decision-tree process (e.g., the XGBoost process), and FIG. 5B illustrates additional steps of the exemplary processes for adaptively training, and cross-validating, the machine-learning or artificial-intelligence processes described herein.

Through a performance of one or more of the exemplary adaptive training and cross-validation processes described herein, FI computing system 130 may generate elements of additional composition data that characterizes a composition of a third input dataset for the adaptively trained, machine-learning or artificial-intelligence process (e.g., combined features and corresponding positions within the third input dataset) and elements of additional process data that include the one or more process parameters of the adaptively trained machine-learning or artificial-intelligence process (e.g., also in step 526 of FIG. 5A). FI computing system 130 may perform operations that store the elements of additional composition data and additional process data within an accessible local or remote data repository, such as within pre-processed data store 141 of FIG. 2A (e.g., in step 528 of FIG. 5A). Exemplary process 500 may then be complete in step 530.

In some examples, FI computing system 130 may perform one or more of the exemplary processes described herein to further characterize an accuracy, and a performance, of the adaptively trained machine-learning or artificial-intelligence process (e.g., the gradient-boosted, decision-tree process described herein) against elements of testing data associated with out-of-time testing interval Δt_{testing} and maintained with the data records of the testing subsets of both the first population (e.g., characterizing the approved and funded applications for the unsecured lending products) and the second population (e.g., characterizing the rejected, or approved but unfunded, applications for the unsecured lending products). Referring to FIG. 5C, FI computing system 130 may obtain the elements of the additional composition data from the locally or remotely accessible data repository (e.g., in step 572 of FIG. 5C), and based on the elements of the additional composition data, FI computing system 130 may perform any of the exemplary processes described herein to generate a plurality of testing datasets based on data records of both the testing subset of the first population (e.g., testing subset 212 of first population 144 of FIG. 3B) and the testing subset of the second population (e.g., testing subset 246 of second population 146 of FIG. 3B) and in some instances, based on previously ingested elements of customer profile, account, transaction, or credit-bureau data, such as those elements of data maintained by aggregated data store 132 (e.g., in step 574 of FIG. 5C).

In some examples, FI computing system 130 may also perform operations that obtain the elements of additional process data, which include one or more process parameters of the adaptively trained machine-learning or artificial-intelligence process (e.g., adaptively trained and cross-validated based on the data records of the training and validation folds of each of the first and second populations) from the locally or remotely accessible data repository (e.g., in step 576 of FIG. 5C). Further, and consistent with the process parameters of the additional process data, FI computing system 130 may also perform any of the exemplary processes described herein to apply the adaptively trained machine-learning or artificial-intelligence process (e.g., the adaptively trained, gradient-boosted, decision-tree process described herein) to the elements of testing data maintained within respective ones of the testing datasets (e.g., in step 578 of FIG. 5C), and to generate corresponding elements of output data (e.g., in step 580 of FIG. 5C). FI computing system 130 may also perform any of the exemplary processes described herein to compute a value of one or more metrics that characterize a predictive capability, and an accuracy, of the adaptively trained, and cross-validated, machine-learning or artificial-intelligence process (e.g., the adaptively trained, and validated, gradient-boosted, decision-tree process) based on the generated elements of output data, corresponding ones of the testing datasets, and corresponding ones of the assigned and inferred ground-truth labels (e.g., in step 582 of FIG. 5C), and to determine whether all, or a selected portion of, the computed metric values satisfy one or more threshold conditions for a deployment of the adaptively trained machine-learning or artificial-intelligence process, such as those described herein (e.g., in step 584 of FIG. 5C).

If, for example, FI computing system 130 were to establish that one, or more, of the computed metric values fail to satisfy at least one of the threshold deployment conditions (e.g., step 584; NO), FI computing system 130 may establish that the adaptively trained, machine-learning or artificial-intelligence process is insufficiently accurate for deployment and may perform operations that initiate, or trigger, a re-training of the machine-learning or artificial-intelligence process using any of the exemplary processes described herein (e.g., in step 586 of FIG. 5C). Exemplary process 570 is then complete in step 588.

Alternatively, if FI computing system 130 were to establish that each computed metric value satisfies threshold requirements (e.g., step 584; YES), FI computing system 130 may deem the adaptively training machine-learning or artificial-intelligence process (e.g., the adaptively trained, gradient-boosted, decision-tree process) ready for deployment. In some instances, FI computing system 130 may perform any of the exemplary processes described herein to generate elements of final input data, which characterize a composition of an input dataset for the adaptively trained, machine-learning or artificial-intelligence process and that identifies each of the feature within the input dataset, along with a sequence or position of these features within the input dataset (e.g., in step 590 of FIG. 5C). FI computing system 130 may also generate elements of final process data that includes the one or more process parameters of the adaptively trained, machine-learning or artificial-intelligence process, such as, but not limited to, each of the exemplary process parameters described herein for the trained, gradient-boosted, decision-tree process (e.g., also in step 590 of FIG. 5C). In some instances, FI computing system 130 may perform operations that store the elements of final input data and final process data within a locally or remotely accessible data repository, such as pre-processed data store 141. Exemplary process 570 is then complete in step 586.

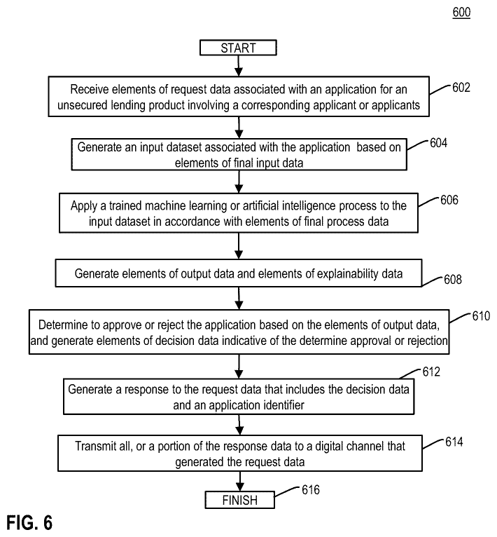

FIG. 6 is a flowchart of an exemplary process 600 for predicting, in real-time, a likelihood of an occurrence, or a non-occurrence, of one or more targeted events involving an unsecured lending product during a future temporal interval using trained, machine-learning or artificial-intelligence processes and inferred ground-truth labelling in multiple data populations. As described herein, the predicted likelihood may associate a corresponding application for the unsecured lending product with an expected positive outcome (e.g., a predicted non-occurrence of any of the targeted events during the future interval) or alternatively, with an expected negative outcome (e.g., a predicted occurrence of at least one of the targeted events during the future interval). Further, the expected positive or negative outcome of the corresponding application may inform a decision by the financial institution to approve or reject the corresponding application for the unsecured lending product, which may be provisioned to a device operable by an applicant or a representative of the financial institution in real-time and contemporaneously with an initiation of the application (e.g., within a threshold time period, such as, but not limited to, ten second, twenty seconds, thirty seconds, or one minute). As described herein, the machine-learning or artificial-intelligence process may include an ensemble or decision-tree process, such as a gradient-boosted, decision-tree process, and in some instances, one or more computing systems, such as, but not limited to, one or more of the distributed components of FI computing system 130, may perform one or of the steps of exemplary process 600, as described herein.

Referring to FIG. 6, FI computing system 130 may perform any of the exemplary processes described herein to receive elements of request data associated with an application for an unsecured lending product, such as a credit-card account, involving a corresponding applicant or corresponding applicants (e.g., in step 602 of FIG. 6). As described herein, FI computing system 130 may receive the elements of request data from a computing system or device associated with a corresponding digital channel, such as, but not limited to, client device 403A of FIG. 4, which may be operable by one of the corresponding applicant (or applicants), or branch device 403B of FIG. 4, which may be operable by a representative of the financial institution. Further, and as described herein, an application program executed by client device 403A, or alternatively, by branch device 403B, may generate the elements of request data and cause a corresponding one of the client device 403A or branch device 403B to transmit the elements of request data across communications network 120 to FI computing system 130.

By way of example, and as described herein, the elements of request data may include an application identifier (e.g., application identifier 410 of FIG. 4), an applicant identifier for each applicant (e.g., applicant identifier 412 of FIG. 4), elements of product data (e.g., product data 414 of FIG. 4), which identify and characterize the unsecured lending product associated with the application, and elements of applicant documentation (e.g., applicant documentation 416 of FIG. 4), which identify and characterize each applicant involved in the corresponding application. In some instances, FI computing system 130 may perform operations that store the received elements of request data within a locally or remotely accessible data repository (e.g., also in step 602).

In some instances, FI computing system 130 may perform any of the exemplary processes described herein to generate an input dataset associated with the application for the unsecured lending product (e.g., in step 604 of FIG. 6). For example, in step 604, FI computing system 130 may perform operations that obtain elements of final composition data (e.g., final composition data 322 of FIGS. 3B and 4), which characterize a composition of an input dataset for the trained machine-learning or artificial-intelligence process (e.g., the adaptively trained, and validated, gradient-boosted, decision-tree process described herein) and identify each of the features within the input dataset, along with a position of these features within the input dataset.

Further, and by way of example, FI computing system 130 perform operations, described herein, that obtain, extract, compute, determine, or derive a value of one or more of the features based on corresponding elements of the request data (e.g., from the elements of product data or applicant documentation), and additionally, or alternatively, based on elements of previously ingested customer profile, account, transaction, or credit-bureau data that characterize the corresponding applicant, or applicants, involved in the application. In some instances, FI computing system 130 may perform any of the exemplary processes described herein to package each of the obtained, extracted, computed, determined, or derived input feature values into corresponding portions of input dataset in accordance with their respective, sequences or positions specified within the elements of the final composition data.

FI computing system 130 may also perform any of the exemplary processes described herein to apply the trained machine-learning or artificial-intelligence process (e.g., the adaptively trained, gradient-boosted, decision-tree process,) to the elements of the input dataset (e.g., in step 606 of FIG. 6). Further, and based on the application of the trained machine-learning or artificial-intelligence process to the elements of the input dataset, FI computing system 130 may perform any of the exemplary processes described herein to generate (i) elements of output data indicative of the predicted likelihood of an occurrence, or a non-occurrence, of one or more targeted events involving the unsecured lending product during the future temporal interval and (ii) elements of explainability data that characterize a relative importance of one or more of the input feature values included the input dataset to the predictive output of the adaptively trained machine-learning or artificial-intelligence process (e.g., in step 608 of FIG. 6).

For example, in step 606, FI computing system 130 may obtain elements of final process data (e.g., final process data 324 of FIGS. 3B and 4) that include one or more process parameters of the trained machine-learning or artificial-intelligence process, such as, but not limited to, one of more of the exemplary process parameters described herein. In some instances, and based on elements of final process data, FI computing system 130 may perform any of the exemplary processes described herein to establish a plurality of nodes and a plurality of decision trees for the adaptively trained machine-learning or artificial-intelligence process, each of which receive, as inputs (e.g., “ingest”), corresponding elements of the input dataset (e.g., also in step 606 of FIG. 6). Based on the ingestion of the input dataset by the established nodes and decision trees of the adaptively trained, gradient-boosted, decision-tree process, FI computing system 130 may perform any of the exemplary processes described generate the elements of output data and the elements of explainability (e.g., also in step 608 of FIG. 6).

FI computing system 130 may also perform any of the exemplary processes described herein that determine to approve, or alternatively, to reject the application for the unsecured lending product characterized by the received elements of request data based on the output data, and generate elements of decision data indicative of the determined approval or rejection of the application for the unsecured lending product (e.g., in step 610 of FIG. 6). As described herein, the elements of output data may, for example, associate the corresponding application for the rewards-based, credit card account with an expected positive outcome (e.g., a predicted non-occurrence of any of the targeted events during the future interval) or alternatively, with an expected negative outcome (e.g., a predicted occurrence of at least one of the targeted events during the future interval).

For example, as described herein, if the elements of output data were to associate the application for the unsecured lending product characterized by the received elements of request data with an expected positive outcome during the future temporal interval, FI computing system 130 may approve the application and may perform any of the exemplary processes described herein, in step 610, to generate the elements of decision data indicative of the determined approval of the application (e.g., a binary value of zero or alphanumeric character string, such as “APPROVED”). Alternatively, if the elements of output data were to associate the application for the unsecured lending product characterized by the received elements of request data with an expected negative outcome during the eighteen-month, future temporal interval, FI computing system 130 may reject the application and may perform any of the exemplary processes described herein, in step 610, to generate the elements of decision data indicative of the determined rejection of the application (e.g., a binary value of unity or alphanumeric character string, such as “REJECT”). FI computing system 130 may also perform operations, described herein, to package the corresponding application identifier and the elements of decision data, which indicates approval, or alternatively, the rejection of the application for the unsecured lending product characterized by the received elements of request data into corresponding portions of a response to the request data (e.g. in step 612 of FIG. 6).

In some instances, FI computing system 130 to perform operations that transmit all, or a selected portion of, the response across communications network 120 to a corresponding one of digital application channels 403 that initiated the application for the unsecured lending product and that generated request 402, e.g., one of client device 403A and branch device 403B (e.g., in step 614 of FIG. 6). In some examples, the application program executed by client device 403A, or by branch device 403B, may process application identifier 410 and the elements of decision data 442, and may perform operations that generate and present, within a corresponding digital interface via the display unit, elements of digital content that confirm, to the customer, the decision to approval, or rejection of the application for the unsecured lending product, within a corresponding digital interface. The customer may, for example, obtain the decision approving or rejecting the application for the unsecured lending product in real-time and contemporaneously with the submission of the application (e.g., within a threshold time period, such as, but not limited to, ten second, twenty seconds, or thirty seconds, of the generation of request 402 by client device 403A or branch device 403B). Exemplary process 600 is then complete in step 616.

### C. Exemplary Hardware and Software Implementations

Embodiments of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Exemplary embodiments of the subject matter described in this specification, including, but not limited to, application programming interface (API) 134 and 404, data ingestion engine 136, pre-processing engine 140, training engine 202, training input module 208, adaptive training module 230, ground-truth inferencing engine 248, feature combination engine 302, real-time predictive engine 406, process input module 408, inferencing module 432, decisioning module 440, can be implemented as one or more computer programs, i.e., one or more modules of computer program instructions encoded on a tangible non transitory program carrier for execution by, or to control the operation of, a data processing apparatus (or a computer system). Additionally, or alternatively, the program instructions can be encoded on an artificially generated propagated signal, such as a machine-generated electrical, optical, or electromagnetic signal that is generated to encode information for transmission to suitable receiver apparatus for execution by a data processing apparatus.

The terms “apparatus,” “device,” and “system” refer to data processing hardware and encompass all kinds of apparatus, devices, and machines for processing data, including, by way of example, a programmable processor such as a graphical processing unit (GPU) or central processing unit (CPU), a computer, or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or combinations thereof.

The one or more computer programs, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program may be stored in a portion of a file that holds other programs or data, such as one or more scripts stored in a markup language document, in a single file dedicated to the program in question, or in multiple coordinated files, such as files that store one or more modules, sub-programs, or portions of code. A computer program may be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array), an ASIC (application-specific integrated circuit), one or more processors, or any other suitable logic. Computers suitable for the execution of a computer program include, by way of example, general or special purpose microprocessors or both, or any other kind of central processing unit. Generally, a CPU will receive instructions and data from a read-only memory or a random access memory or both. The computer may also include, or be operatively coupled to receive data from or transfer data to, or both, one or more mass storage devices for storing data, such as magnetic, magneto-optical disks, or optical disks. Further, the computer may be embedded in another device, such as a mobile telephone, a personal digital assistant (PDA), a mobile audio or video player, a game console, a Global Positioning System (GPS) receiver, or a portable storage device, such as a universal serial bus (USB) flash drive, to name just a few. Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

Implementations of the subject matter described in this specification can be implemented in a computing system that includes a back-end component, such as a data server, or that includes a middleware component, such as an application server, or that includes a front-end component, such as a computer having a graphical user interface or a web browser through which a user can interact with an implementation of the subject matter described in this specification, or any combination of one or more such back-end, middleware, or front-end components. The components of the computing system can be interconnected by any form or medium of digital data communication, such as a communication network, and examples of communication networks include a local area network (LAN) and a wide area network (WAN), such as the Internet. The computing system may include clients and servers remote from each other and that interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the device, such as a result of the user interaction, can be received from the device at the server.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

What is claimed is:

1. An apparatus, comprising:
a memory storing instructions;
a communications interface; and
at least one processor coupled to the memory and the communications interface, the at least one processor being configured to execute the instructions to:
receive, from a device via the communications interface, application data characterizing an exchange of data;
based on an application of an artificial-intelligence process to an input dataset that includes at least a portion of the application data, generate, in real time, output data indicative of a likelihood of an occurrence of at least one targeted event associated with the data exchange during a future temporal interval, the artificial-intelligence process being trained using datasets associated with inferred ground-truth labels; and
transmit at least a portion of the output data to the device via the communications interface, the device being configured to present a graphical representation of the portion of the output data within a digital interface.

2. The apparatus of claim 1, wherein:
the application data characterizes an application for the data exchange, the application involving an applicant; and
the at least one processor is further configured to execute the instructions to generate the input dataset based on at least the portion of the application data and on interaction data characterizing the applicant.

3. The apparatus of claim 2, wherein the at least one processor is further configured to execute the instructions to:
obtain data that characterizes a composition of the input dataset; and
based on the data that characterizes the composition, perform operations that (i) extract a first feature value from at least one of the portion of the application data or a portion of the interaction data and that (ii) compute a second feature value based on at least one of the portion of the application data or the portion of the interaction data; and
generate the input dataset based on at least one of the extracted first feature value or the computed second feature value.

4. The apparatus of claim 2, wherein:
the application data comprises an identifier of the applicant; and
the at least one processor is further configured to execute the instructions to:
obtain at least a portion of the interaction data from the memory based on the identifier of the applicant; and
generate the input dataset based on the portion of the application data and on the portion of the interaction data.

5. The apparatus of claim 2, wherein the at least one processor is further configured to execute the instructions to:
based on the output data, generate decision data associated with a decision to approve the application for the data exchange; and
transmit at least a portion of the decision data to the device via the communications interface, the portion of the decision data causing an application program executed by the device to generate, and present within the digital interface, elements of digital content that characterize the decision to approve the application.

6. The apparatus of claim 1, wherein:
the device is operable by an applicant associated with the application data, and the application data is generated by an application program executed by the device; and
the executed application program causes the device to present the graphical representation of the portion of the output data within the digital interface.

7. The apparatus of claim 1, wherein the at least one processor is further configured to execute the instructions to:
obtain (i) data that characterizes a composition of the input dataset and (ii) one or more process parameters that characterize the trained artificial-intelligence process;
generate the input dataset in accordance with the data that characterizes the composition; and
apply the trained artificial-intelligence process to the input dataset in accordance with the one or more process parameters.

8. The apparatus of claim 1, wherein the trained artificial-intelligence process comprises a trained, gradient-boosted, decision-tree process.

9. The apparatus of claim 1, wherein the at least one processor is further configured to execute the instructions to:
obtain additional application data from the memory, the elements of additional application data being associated with one or more temporal intervals;
determine that the elements of the additional application data are associated with corresponding ones of a first element population and a second element population;
generate a plurality of first datasets based on the elements of the additional application data associated with the first element population, and perform operations that assign a ground-truth label to each of the first datasets based on corresponding elements of interaction data; and
perform operations that train the artificial-intelligence process based on the first datasets and corresponding ones of the assigned ground-truth labels, and generate first composition data and explainability data, the first composition data identifying a plurality of first sequential features, and the explainability data characterizing an impact of each of the first sequential features on an output of the artificial-intelligence process.

10. The apparatus of claim 9, wherein the at least one processor is further configured to execute the instructions to:
generate a plurality of second datasets based on the elements of the additional application data associated with the second element population;
based on the explainability data and on interaction data associated with the second element population, perform operations that generate a corresponding one of the inferred ground-truth labels for each of the second datasets; and
perform operations that train the artificial-intelligence process based on the second datasets and corresponding ones of the inferred ground-truth labels and generate second composition data, the elements of second composition data identifying a plurality of second sequential features.

11. The apparatus of claim 10, wherein the at least one processor is further configured to:
generate combined composition data based on the first and second composition data, the combined composition data identifying combined sequential features that include at least one of the first sequential features and at least one of the second sequential features; and
generate a plurality of third input datasets based on elements of the additional application data associated with the first and second element populations, each of the third input datasets having a composition consistent with the combined composition data; and
perform operations that train the artificial-intelligence process based on the third datasets and corresponding ones of the assigned and inferred ground-truth labels, and generate final composition data and final process data, the elements of final composition data identifying a plurality of final sequential features, and the final process data comprising a final value of one or more process parameters.

12. A computer-implemented method, comprising:
receiving, using at least one processor and from a device, application data characterizing an exchange of data;
using the at least one processor, and based on an application of an artificial-intelligence process to an input dataset that includes at least a portion of the application data, generating, in real time, output data indicative of a likelihood of an occurrence of at least one targeted event associated with the data exchange during a future temporal interval, the artificial-intelligence process being trained using datasets associated with inferred ground-truth labels; and
transmitting, using the at least one processor, at least a portion of the output data to the device, the device being configured to present a graphical representation of the portion of the output data within a digital interface.

13. The computer-implemented method of claim 12, wherein:
the application data characterizes an application for the data exchange, the application involving an applicant; and
the generating comprises generating the input dataset based on at least the portion of the application data and on interaction data characterizing the applicant.

14. The computer-implemented method of claim 13, wherein:
the computer-implemented method further comprises:
obtaining, using the at least one processor, data that characterizes a composition of the input dataset; and
based on the data that characterizes the composition, performing operations, using the at least one processor, that (i) extract a first feature value from at least one of the portion of the application data or a portion of the interaction data and that (ii) compute a second feature value based on at least one of the portion of the application data or the portion of the interaction data; and
the generating comprises generating the input dataset based on at least one of the extracted first feature value or the computed second feature value.

15. The computer-implemented method of claim 13, wherein:
the application data comprises an identifier of the applicant; and
the computer-implemented method further comprises obtaining, using the at least one processor, at least a portion of the interaction data from a data repository based on the identifier of the applicant; and
the generating comprises generating the input dataset based on the portion of the application data and on the portion of the interaction data.

16. The computer-implemented method of claim 12, wherein:
the computer-implemented method further comprises obtaining, using the at least one processor, (i) data that characterizes a composition of the input dataset and (ii) one or more process parameters that characterize the trained artificial-intelligence process;
the generating comprises generating the input dataset in accordance with the data that characterizes the composition; and
the computer-implemented method further comprises applying, using the at least one processor, the trained artificial-intelligence process to the input dataset in accordance with the one or more process parameters.

17. The computer-implemented method of claim 12, further comprising:
obtaining elements of additional application data from a data repository using the at least one processor, the elements of additional application data being associated with one or more temporal intervals;
determining, using the at least one processor, that the elements of the additional application data are associated with corresponding ones of a first element population and a second element population;
using the at least one processor, generating a plurality of first datasets based on the elements of the additional application data associated with the first element population, and performing operations that assign a ground-truth label to each of the first datasets based on corresponding elements of interaction data; and
performing operations, using the at least one processor, that train the artificial-intelligence process based on the first datasets and corresponding ones of the assigned ground-truth labels, and that generate first composition data and explainability data, the first composition data identifying a plurality of first sequential features, and the explainability data characterizing an impact of each of the first sequential features on an output of the artificial-intelligence process.

18. The computer-implemented method of claim 17, further comprising:
generating, using the at least one processor, a plurality of second datasets based on the elements of the additional application data associated with the second element population;
based on the elements of explainability data and on interaction data associated with the second element population, performing operations, using the at least one processor, that generate a corresponding one of the inferred ground-truth labels for each of the second datasets; and
performing operations, using the at least one processor, that further train the artificial-intelligence process based on the second datasets and corresponding ones of the inferred ground-truth labels, and that generate second composition data, the second composition data identifying a plurality of second sequential features.

19. The computer-implemented method of claim 18, further comprising:
generating, using the at least one processor, combined composition data based on the first and second composition data, the combined composition data identifying combined sequential features that include at least one of the first sequential features and at least one of the second sequential features;
generating, using the at least one processor, a plurality of third input datasets based on the elements of the additional application data associated with the first and second element populations, each of the third input datasets having a composition consistent with the combined composition data; and
performing operations, using the at least one processor, that further train the artificial-intelligence process based on the third datasets and corresponding ones of the assigned and inferred ground-truth labels, and that generate elements of final composition data and final process data associated, the elements of final composition data identifying a plurality of final sequential features, and the elements of final process data comprising a final value of one or more process parameters.

20. A tangible, non-transitory computer-readable medium storing instructions that, when executed by at least one processor, cause the at least one processor to perform a method, comprising:
receiving, from a device, application data characterizing an exchange of data;
based on an application of an artificial-intelligence process to an input dataset that includes at least a portion of the application data, generating, in real time, output data indicative of a likelihood of an occurrence of at least one targeted event associated with the data exchange during a future temporal interval, the artificial-intelligence process being trained using datasets associated with inferred ground-truth labels; and
transmitting at least a portion of the output data to the device, the device being configured to present a graphical representation of the portion of the output data within a digital interface.
